(19) United States
(12) Patent Application Publication
(10) Pub. No.: US 2022/0076653 A1
(43) Pub. Date: Mar. 10, 2022

(54) CONTROL METHOD OF SOUND ABSORPTION CHARACTERISTICS OF SOUNDPROOF MATERIAL

(71) Applicant: Maxell Holdings, Ltd., Kyoto (JP)

(72) Inventors: Norikazu MATSUMOTO, Otokuni-gun, Kyoto (JP); Shoko SAKAI, Otokuni-gun, Kyoto (JP); Kenji OHTANI, Otokuni-gun, Kyoto (JP); Teruhisa MIYATA, Otokuni-gun, Kyoto (JP)

(21) Appl. No.: 17/299,191

(22) PCT Filed: Dec. 2, 2019
(86) PCT No.: PCT/JP2019/047055

§ 371 Date: Jun. 2, 2021

(30) Foreign Application Priority Data
Dec. 4, 2018 (JP) 2018-227599

(51) Int. Cl. G10K 11/168

(52) U.S. Cl. CPC G10K 11/168; B32B 5/26

(57) ABSTRACT

A control method of sound absorption characteristics of a soundproof material is provided to change the sound absorption characteristics of the soundproof material while equally maintaining constituent materials, total thickness, and total weight of the soundproof material. The soundproof material includes: a surface cover layer composed of a fiber material; a back-surface layer laminated onto the surface cover layer, and composed of a porous material with voids interconnected with each other; and one or more joining layers laminated between the surface cover layer and the back-surface layer, each joining layer being composed of a joining material, having a total joint area percentage of less than 100% with respect to the entire contact surface between the surface cover layer and the back-surface layer. The sound absorption characteristics are changed by changing the areas of the joining layers.

### CROSS REFERENCE TO RELATED APPLICATIONS

This application is the U.S. National Phase under 35 U.S.C. § 371 of International Application No. PCT/JP2019/047055, filed on Dec. 2, 2019, which claims the benefits of Japanese Application No. 2018-227599, filed on Dec. 4, 2018, the entire contents of which are hereby incorporated by reference.

### TECHNICAL FIELD

The present invention relates to a soundproof material, and in particular relates to a control method of sound absorption characteristics of a soundproof material.

### BACKGROUND ART

In recent years, it has become clear that people tend to live at high population densities in small areas due to the progress of urbanization or the efficiency of administrative services. As the population density increases, activities such as life, labor, and entertainment will be carried out in close proximity, and the frequency and types of noises that consumers will came into contact with will increase. In order to secure a comfortable living environment even in a noisy environment, a soundproof material is required which can generally block out daily life noises that they encounter. Further, with miniaturization and lightening of various devices which are sound bodies of daily life noises, thinning and lightening are required also to soundproof materials used in them.

Daily life noises are emitted from, for example, transportation devices, construction machines/devices, electronic/electrical devices, home electrical appliances and the like, and they are diverse types, including sounds over a wide range of frequencies from low frequency to high frequency.

Taking the case of an automobile as an example, the range of sound intruding a roam interior while the automobile is running has a characteristic of exhibiting peaks in the low sound range of engine sound (about 63 to 250 Hz), and in the medium to high sound ranges such as tire sound (about 500 to 1500 Hz) and wind sound (about 1000 to 4000 Hz). In general, there are two types of soundproofing methods for automobiles: “sound insulation” to block out the sound intruding from outside the automobile and “sound absorption” to soften the sound inside the automobile, and measures against intruding sound are taken by methods such as sound insulation in the low sound range and sound absorption in the medium and high sound ranges. In order to soften the sound in the medium to high sound range, which is a characteristic of tire sound and wind sound, and for which there is a concern that the problem will become more prominent in next-generation automobiles, the soundproof material is required to have better sound absorption performance than conventional products, whereas there is also a demand for a control method of sound absorption characteristics which can appropriately and easily design the desired sound absorption characteristics after maintaining the thinness and lightness as much as possible. Furthermore, in order to create a comfortable sound environment depending on the situation, with respect to the sound in a predetermined frequency range, it is expected that there will also be an increasing demand for not only just improving sound absorption performance but also wishing to easily adjust the sound absorption coefficient to an appropriate level.

The above-described “sound absorption” is one of the soundproofing methods for blocking out noises and abnormal sounds. Here, “sound absorption” refers to a method of suppressing sound reflection by absorbing sound, and the smaller the loudness of the sound reflected by absorption, the higher the sound absorption. The sound absorption mechanism is such that when sound is incident on a material composed of a skeleton part of fiber materials, such as felt, glass wool, and rock wool, and voids therebetween, part of energy of sound waves is converted into heat energy in the voids by friction with peripheral walls of the skeleton part, viscous resistance, vibration of the skeleton and the like, resulting in the sound being absorbed. In the sound, since sound energy consumption is maximized at a position where the particle velocity of sound waves is high, for example, if there is a sound absorbing material from a rigid wall to a position such as λ/4 where the particle velocity is high, the sound absorption coefficient is increased. Therefore, for example, in the material attached to the rigid wall, the higher the frequency, the higher the sound absorption coefficient. Also, the larger the thickness of the sound absorbing material, the more the sound absorption coefficient on the low frequency side can be increased.

Therefore, in order to design a soundproof material having a high-level sound absorption coefficient, which is more effective than conventional soundproof materials, and having an expanded sound-absorbable frequency region, increasing the thickness of fiber material becomes one of the effective methods. This method is effective when there is no limitation in the thickness of the soundproof material, but it is inappropriate for use intended for thinning and lightening purposes as described above. Therefore, instead of increasing the thickness of the fiber material such as felt, a method is proposed in which sound absorption characteristics are improved by a soundproof material obtained by joining and laminating a specific thin surface cover material, a film-like resonance material and the like by using a thermally fused fiber or an adhesive, while maintaining the thinness and lightness as much as possible.

Patent Document 1 discloses an ultra-lightweight soundproof material that prevents noise in such as an engine room of an automobile from propagating into a vehicle interior. This soundproof material comprises a laminated body in which a sound absorbing layer composed of an air-permeable material such as a thermoplastic felt and an air-permeable resonance layer composed of a lightweight foam body or a thin film body or like that are bonded together by an adhesion layer so that it has a predetermined adhesive strength and an adhesive area.

In the soundproof material of Patent Document 1, by the use of the adhesion layer between the air-permeable resonance layer and sound absorbing layer, a resonance phenomenon is expressed at an interface between the air-permeable ultra-light resonance layer and sound absorbing layer, whereby the sound is absorbed. The spring-mass system resonance and rigidity are adjusted according to the bonding area and density of the sound absorbing layer to control the frequency and sound absorption coefficient of the sound absorbed at the interface.

Patent Document 2 discloses a sound absorbing material suitable for an automobile interior and the like. The sound-absorbing material is a nonwoven fabric obtained by joining a surface material composed of a thermoplastic synthetic long fiber nonwoven fabric by the spun-bond method, which was further subjected to calendering after partial thermal contact bonding, and aback surface material composed of a synthetic fiber nonwoven fabric by using a hot-melt adhesive or the like.

Since the sound absorbing material of Patent Document 2 is composed of a high-density synthetic thermoplastic fiber nonwoven fabric with its surface cover having small voids, the wavelength of sound is reduced, allowed to intrude the voids of the nonwoven fabric, and the sound waves that have intruded are transferred to vibrate the fiber single thread of the back surface material made of coarse synthetic fiber non-woven fabric with large voids, thus making it possible to efficiently convert sound energy into heat energy, as well as possible to obtain an excellent sound absorbing effect.

Patent Document 3 discloses an automobile floor laying material to be laid on a floor panel in an automobile interior. This laying material is a laying material formed by laminating a cushion layer, a perforated sheet layer having many openings, and an air-permeable surface layer in this order on a floor panel.

For the laying material of Patent Document 3, the flow resistance value of the lamination of the perforated sheet layer and the air-permeable surface layer is adjusted to less than 1000 Nsm⁻³ by determining factors such as the aperture ratio of the perforated sheet layer, thereby optionally controlling sound absorbing properties and sound insulating properties in the range of 100 to 3000 Hz.

Patent Document 4 discloses a composite sound absorbing structure relating to a sound absorbing structure using a fiber-based porous material. This composite sound absorbing structure comprises a surface cover layer composed of a nonwoven fabric in which single fiber has a circular or flat shape, and a diameter of 11 to 35 μm in terms of equivalent single fiber diameter, and a base material layer composed of a polymer fiber-based porous material that are superposed through a hot-melt material, heated and pressurized, and thermally fused so as to be integrally composited, the surface cover layer of a nonwoven fabric being arranged on the incident side of sound.

The composite sound absorbing structure of Patent Document 4 is composed of a polymer-based hot melt adhesive with a basis weight, and a plurality of surface cover layers, thereby, as the composite sound absorbing structure, adjusting the flow resistance to 2×10⁴ to 3.5×10⁴ N·sec/m⁴ and controlling it so that it has excellent sound absorption characteristics in a wide frequency range.

### PRIOR ART DOCUMENTS

### Patent Documents

### Patent Document 1 JP 2005-208494 A

### Patent Document 2 JP 2006-28709 A

### Patent Document 3 JP 2005-1403 A

### Patent Document 4 WO 2009-125742 A

### SUMMARY OF INVENTION

### Problem to be Solved by Invention

However, in the above-mentioned technologies of Patent Documents 1 to 4, for example, with respect to the adjustment request including: “In the design specification of a soundproof material currently under study, (1) not wishing change of use material, (2) not wishing an increase in the total weight of the soundproof material any further, (3) also not wishing to increase the total thickness any further, but (A) wishing to shift the sound-absorbable frequency range a little more, (B) wishing to adjust the level of the sound absorption coefficient in some frequency range, (C) since there was a specification change to the sound absorption characteristics from the original schedule, wishing to shift the sound-absorbable frequency range significantly”, it cannot be said that they are fully met, and there was still room for improvement. That is, there has been a demand for a new control method capable of significantly changing the sound absorption characteristics compared to the conventional technologies while maintaining the total weight, total thickness and constituent materials of the soundproof material in the current design as much as possible.

The present invention solve the above conventional problem, and an object thereof resides in providing a control method of sound absorption characteristics, which varies the sound absorption characteristics without changing the constituent materials, total thickness and total weight of the soundproof material.

### Means for Solving the Problem

In order to solve the above problem, based on a soundproof material already proposed by the present inventors, in which a surface cover layer composed of a predetermined fiber material and a back-surface layer composed of a porous material with voids interconnected with each other are partially joined by a joining layer so that it has a predetermined joint area percentage (Japanese Patent Application No. 2018-146130), the present inventors further studied in detail. The total joint area percentage means the ratio of the total area of the joining layer(s) to the entire contact surface between the surface cover layer and the back-surface layer. Here, the contact surface refers to a surface where the surface cover layer and back-surface layer face each other.

As a result, we found a phenomenon that, even if the total joint area percentage is identical, in other words, when the joining layers are arranged by changing the area of the individual joining layers without changing the weight and total thickness of the soundproof material, the sound absorption characteristics of the soundproof material substantially change, thus completing the present invention.

A first invention in the present invention provides a method of controlling sound absorption characteristics of a soundproof material, the soundproof material comprising:
a surface cover layer composed of a fiber material;
a back-surface layer laminated onto the surface cover layer, and composed of a porous material with voids interconnected with each other; and
one or more joining layers laminated between the surface cover layer and the back-surface layer, each joining layer being composed of a joining material, having a total joint area percentage of less than 100% with respect to the entire contact surface between the surface cover layer and the back-surface layer,
wherein the sound absorption characteristics are changed by changing individual areas of the joining layers.

In one embodiment of the first invention, the total joint area percentage is selected from the range of 50 to 95%.

In one embodiment of the first invention, the joining material is a coated pressure-sensitive adhesive or double-sided pressure-sensitive adhesive tape.

In one embodiment of the first invention, the plurality of joining layers exists on the contact surface between the surface cover layer and the back-surface layer.

In one embodiment of the first invention, the plurality of joining layers has a regular arrangement style.

In one embodiment of the first invention, the joining layer has a bar-like shape.

In one embodiment of the first invention, the absorption peak frequency of the soundproof material can be shifted to the lower frequency side by increasing the individual areas of the joining layers, or the absorption peak frequency of the soundproof material can be shifted to the higher frequency side by decreasing the individual areas of the joining layers.

In one embodiment of the first invention,

by increasing the individual areas of the joining layers, the sound absorption coefficient on the higher frequency range side of the sound absorption peak frequency of the soundproof material can be reduced, and the sound absorption coefficient on the lower frequency range side of the sound absorption peak frequency can be increased, or by reducing the individual areas of the joining layers, the sound absorption coefficient on the higher frequency range side of the sound absorption peak frequency of the soundproof material can be increased, and the sound absorption coefficient on the lower frequency range side can be reduced.

Also, a second invention in the present invention provides a method of controlling sound absorption characteristics of a soundproof material, the soundproof material comprising: a surface cover layer composed of a fiber material; a back-surface layer laminated onto the surface cover layer, and composed of a porous material with voids interconnected with each other; and a joining layer laminated between the surface cover layer and the back-surface layer, and composed of a joining material, the joining layer having a total joint area percentage of less than 100% with respect to the entire contact surface between the surface cover layer and the back-surface layer, wherein, on at least a part of the contact surface between the surface cover layer and the back-surface layer, one or more regional areas, each being composed of a plurality of joining layers having a predetermined arrangement style, are arranged, thereby changing the sound absorption characteristics of the soundproof material.

In one embodiment of the second invention, if there is a regional area where, a regional area composed of a plurality of joining layers, is not arranged on the contact surface between the surface cover layer and the back-surface layer, a regional area composed of one joining layer, which has a larger area than the each joining layer, is arranged on at least part of the regional area.

In one embodiment of the second invention, the sound absorption coefficient of the soundproof material in the low to high frequency ranges can be leveled.

Further, the fiber material of the surface cover layer of the present invention preferably has a basis weight of 5 to 300 g/m², an average fiber diameter of 1 to 17 μm, and an air-permeation volume of 5 to 200 cm³/cm²·sec.

Further, the back-surface layer of the present invention preferably has a unit-area flow resistance of 0.5×10⁴ to 3.5×10⁴ N·sec/m⁴.

Moreover, the back-surface layer of the present invention is preferably composed of a fir material which has a basis weight of 100 to 300 g/m².

Further, the coated pressure-sensitive adhesive or double-sided pressure-sensitive adhesive tape has a shear storage elastic modulus of 1.0×10⁴ to 1.0×10⁶ Pa at 25° C.

### Effect of the Invention

The controlling method of sound absorption characteristics of the present invention can change the sound absorption characteristics of the soundproof material without changing the constituent materials, total thickness, and total weight of the soundproof material, and can more easily provide the design of sound absorption characteristics according to various applications.

### BRIEF DESCRIPTION OF DRAWINGS

FIG. 1 is a perspective view schematically showing the constitution of soundproof material used in the method of the present invention.

FIG. 2 is a horizontal cross-sectional view showing an arrangement style of a plurality of joining layers used in Examples 1 and 16 of the present invention.

FIG. 3 is a horizontal cross-sectional view showing an arrangement style of a plurality of joining layers used in Examples 2 and 17 of the present invention.

FIG. 4 is a horizontal cross-sectional view showing an arrangement style of a plurality of joining layers used in Example 3 of the present invention.

FIG. 5 is a horizontal cross-sectional view showing an arrangement style of a plurality of joining layers used in Examples 4 and 18 of the present invention.

FIG. 6 is a horizontal cross-sectional view showing an arrangement style of a plurality of joining layers used in Example 5 of the present invention.

FIG. 7 is a horizontal cross-sectional view showing an arrangement style of a plurality of joining layers used in Example 6 of the present invention.

FIG. 8 is a horizontal cross-sectional view showing an arrangement style of a plurality of joining layers used in Example 7 of the present invention.

FIG. 9 is a horizontal cross-sectional view showing an arrangement style of a plurality of joining layers used in Example 8 of the present invention.

FIG. 10 is a horizontal cross-sectional view showing an arrangement style of a plurality of joining layers used in Example 9 of the present invention.

FIG. 11 is a horizontal cross-sectional view showing an arrangement style of a plurality of joining layers used in Example 10 of the present invention.

FIG. 12 is a horizontal cross-sectional view showing an arrangement style of a plurality of joining layers used in Example 11 of the present invention.

FIG. 13 is a horizontal cross-sectional view showing an arrangement style of a plurality of joining layers used in Example 12 of the present invention.

FIG. 14 is a horizontal cross-sectional view showing an arrangement style of a plurality of joining layers used in Example 13 of the present invention.

FIG. 15 is a horizontal cross-sectional view showing an arrangement style of a plurality of joining layers used in Example 14 of the present invention.

FIG. 16 is a horizontal cross-sectional view showing an arrangement style of a plurality of joining layers used in Example 15 of the present invention.

FIG. 17 is a graph obtained by plotting sound absorption coefficients of soundproof materials obtained in Examples 1 to 3 for each ⅓ octave band center frequency.

FIG. 18 is a graph obtained by plotting sound absorption coefficients of soundproof materials obtained in Examples 1, 4, and 5 for each ⅓ octave band center frequency.

FIG. 19 is a graph obtained by plotting sound absorption coefficients of soundproof materials obtained in Examples 6 to 8 for each ⅓ octave band center frequency.

FIG. 20 is a graph obtained by plotting sound absorption coefficients of soundproof materials obtained in Examples 6, 9, and 10 for each ⅓ octave band center frequency.

FIG. 21 is a graph obtained by plotting sound absorption coefficients of soundproof materials obtained in Examples 11 to 13 for each ⅓ octave band center frequency.

FIG. 22 is a graph obtained by plotting sound absorption coefficients of soundproof materials obtained in Examples 11, 14, and 15 for each ⅓ octave band center frequency.

FIG. 23 is a graph obtained by plotting sound absorption coefficients of soundproof materials obtained in Examples 16 and 17 for each ⅓ octave band center frequency.

FIG. 24 is a graph obtained by plotting sound absorption coefficients of soundproof materials obtained in Examples 16 and 18 for each ⅓ octave band center frequency.

### DESCRIPTION OF EMBODIMENTS

### [Constitution of Soundproof Material]

The present invention will be described in detail with reference to the attached drawings.

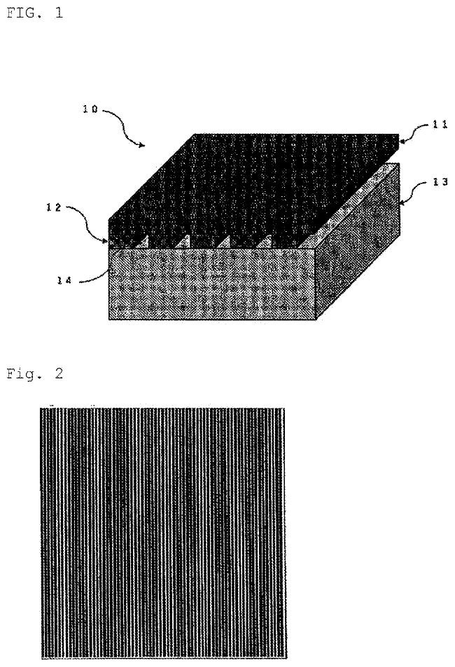

FIG. 1 is a perspective view schematically showing the constitution of a soundproof material according to an embodiment of the present invention. A soundproof material 10 has a laminated structure including a surface cover layer 11 composed of a fiber material, a back-surface layer 13 composed of a porous material with voids interconnected with each other, a joining layer 12, and air-permeable openings 14. The soundproof material 10 may be used as a member for absorbing sound emitted from sounding bodies such as transportation equipment, construction machinery/equipment, electronic/electrical equipment, and home electrical appliances, as well as a member for adjusting a sound field environment in a public building and in the vicinity.

### <Joining Layer>

The joining layer 12 is a layer for joining surface cover layer 11 and back-surface layer described below. The joining layer 12 is formed on a part of a contact surface between the surface cover layer 11 and back-surface layer 13 (hereinafter, it may be simply referred to as a “contact surface”). In the present specification, the joining layer refers to one member, not an aggregate. The area of the joining layer refers to an area of the joining layer which is substantially parallel to the above contact surface. Each individual area of the joining layer refers to an area of one joining layer. A singular or a plurality of joining layers 12 may be formed.

As the joining material, a material that can easily and accurately realize the shape and dimensions, and has substantially no interconnected voids. For the joining material, for example, materials containing a pressure-sensitive adhesive, an adhesive, and the like may be used. Specific examples thereof include a coated pressure-sensitive adhesive, a coated adhesive, or those processed into a tape, a sheet, or a powder. Among them, from the viewpoint of workability, productivity, and dimensional accuracy, it is preferable that the joining layer 12 is formed with a coated pressure-sensitive adhesive or a double-sided adhesive tape (including a substrate-less double-sided adhesive tape having no substrate).

The pressure-sensitive adhesive used for the above coated pressure-sensitive adhesive or double-sided pressure-sensitive adhesive tape is not particularly limited, and a conventional, publicly known pressure-sensitive adhesive may be used. For example, it includes a rubber-based pressure-sensitive adhesive, an acrylic-based pressure-sensitive adhesive, a silicone-based pressure-sensitive adhesive, a urethane-based pressure-sensitive adhesive, a polyester-based pressure-sensitive adhesive, an ethylene-vinyl acetate copolymer-based pressure-sensitive adhesive and the like. Among these, a rubber-based pressure-sensitive adhesive or an acrylic-based pressure-sensitive adhesive is preferable from the viewpoints of versatility, a wide variable range in the thickness, not excessively constraining the surface cover layer and the back-surface layer, and the like. The shear storage elastic modulus (G′) of the pressure-sensitive adhesive at 25° C. is preferably in the range of 1.0×10⁴ to 1.0×10⁶ Pa. By setting the shear storage elastic modulus within such a range, deformation and displacement of the surface cover layer 11 and the back-surface layer 13 due to sound vibrations are possible to some extent, it is possible to pass sound waves to some extent without generating a hard portion that reflects sound at a boundary portion between the surface cover layer 11 and the back-surface layer 13, and possible to make the sound absorption mechanism of the surface cover layer 11, the back-surface layer 13 and the soundproof material 10 function as a whole without any problems. The shear storage elastic modulus (G′) of the pressure-sensitive adhesive at 25° C. is preferably in the range of 5.0×10⁴ to 8.0×10⁵ Pa, and more preferably in the range of 1.0×10⁵ to 6.0×10⁵ Pa.

Regarding the joining layer, in a soundproof material already proposed by the present inventors, in which a surface cover layer composed of a predetermined fiber material and a back-surface layer composed of a porous material with voids interconnected with each other are partially joined by a joining layer so that it has a predetermined joint area percentage (Japanese Patent Application No. 2018-146130), the present inventors show as follows: the soundproof material is configured to couple resonance at a joint interface and vibrations in the surface-cover layer and the back surface layer, and also to make use of a resonance type sound absorption mechanism with the back-surface layer, and viscous resistance of the back-surface layer by the openings in the joining layer. Therefore, the respective sound absorbing mechanisms are synergistically expressed in a balanced manner, and, even if the total thickness of the soundproof material is thin, it achieves the effect of having a practically useful high-level normal incidence sound absorption coefficient, and further having an expanded sound-absorbable frequency range. In the present invention, based on the proposed technique, we further studied the relationship between the sound absorption coefficient measured by the reverberation room method closer to the actual environment (reverberation room method sound absorption coefficient) and the arrangement style of the joining layers. As a result, as described above, we found a phenomenon that, even if the total joint area percentage is identical, in other words, when the joining layers are arranged by changing the individual areas without changing the weight and total thickness of the soundproof material, the sound absorption characteristics of the soundproof material substantially change. That is, in a soundproof material comprising a surface cover layer composed of a fiber material, a back-surface layer laminated onto the surface cover layer, and composed of a porous material with voids interconnected with each other, and one or more joining layers laminated between the surface cover layer and the back-surface layer, each joining layer being composed of a joining material, having a total joint area percentage of less than 100% with respect to the entire contact surface between the surface cover layer and the back-surface layer, when the total joint area percentage is set to one value in the predetermined range, we found firstly that the sound absorption characteristics of the soundproof material can be changed by changing the individual areas of the joining layers, and secondly that the sound absorption characteristics of the soundproof material can be changed by arranging one or more regional areas, each being composed of a plurality of joining layers having a predetermined arrangement style, on at least a part of the contact surface between the surface cover layer and the back-surface layer.

Describing in more detail the first invention, even if the total joint area percentage is identical, the frequency at which the sound absorption coefficient becomes a maximum (sound absorption peak frequency) can be shifted to the lower frequency side by arranging the joining layers by increasing the individual areas of the joining layers. In this case, a tendency is observed that the sound absorption coefficient on the higher frequency range side of the sound absorption peak frequency decreases, and the sound absorption coefficient on the lower frequency range side of the sound absorption peak frequency increases. Conversely, the frequency at which the sound absorption coefficient becomes a maximum (sound absorption peak frequency) can be shifted to the higher frequency side by arranging the joining layers by decreasing the individual areas of the joining layers. In this case, a tendency is observed that the sound absorption coefficient on the higher frequency range side of the sound absorption peak frequency increases, and the sound absorption coefficient on the lower frequency range side of the sound absorption peak frequency decreases. It is also possible to decrease the sound absorption coefficient overall after securing the sound absorption coefficient at a certain level.

The mechanism of achieving the above effect is presumed as follows. It is considered that the structure in which the surface cover layer 11 and the back-surface layer 13 are partially joined by the joining layer 12 shows a structure having a so-called porous type sound absorbing mechanism (back-surface layer 13), resonance type sound absorbing mechanism (laminated structure of openings 14 and back-surface layer 13), and membrane-oscillation-type sound absorbing mechanism (joint interface between the surface cover layer 11 and the joining layer 12, and the back-surface layer 13). Changing the individual areas of the joining layers, in other words means changing the balance of the above three sound absorbing mechanisms. That is, increasing the individual areas of the joining layers without changing the total joint area percentage of the joining layers leads to the effect of the influence of the membrane-oscillation-type sound absorbing mechanism becoming particularly strong (because the number of openings formed decreases, influence of the effect of the porous type sound absorbing mechanism and the resonance type sound absorbing mechanism becomes weak, and because the area of the joint interface constrained by the joining layer formed by one continuous surface increases, leading to the effect of the influence of the membrane-oscillation-type sound absorbing mechanism becoming strong at the joint interface) in the balance of the three sound absorbing mechanisms, and it is therefore considered that the sound absorption peak frequency can be shifted to the lower frequency side. Conversely, decreasing the areas of the joining layers leads to the effect of the influence of the porous type sound-absorbing mechanism becoming particularly strong (because the area of the joint interface constrained by the joining layer formed by one continuous surface decreases, influence of the membrane-oscillation-type sound absorbing mechanism at the joint interface becomes weak, and because the number of openings formed increases, leading to the effect of the influence of the porous type sound absorbing mechanism and the resonance type sound absorbing mechanism becoming strong) in the balance of the three sound absorbing mechanisms, and it is therefore considered that the sound absorption peak frequency can be shifted to the higher frequency side. Further, increasing the individual joint areas without changing the total joint area percentage of the joining layers decreases the number of air-permeable openings 14 formed between the joining layers making it difficult to form and arrange openings 14 evenly over the soundproof material. Therefore, in the case of measurement assuming random incident sound such as the reverberation method sound absorption coefficient test, as for sound obliquely incident through the surface cover layer 11, particularly, the ratio of sound capable of penetrating an upper part (a side in contact with the joining layer) of the back-surface layer 13 arranged directly below the joining layer 12 with a particularly increased area decreases, and a part of the effect of the porous type sound absorbing mechanism of the back-surface layer 13 is suppressed. As a result, it is considered that the sound absorption coefficient can be decreased overall. Conversely, decreasing the individual areas of the joining layers increases the number of air permeable openings 14 formed between the joining layers making it easy to form and arrange openings 14 evenly over the soundproof material, in the case of measurement assuming random incident sound such as the reverberation method sound absorption coefficient test, as for sound obliquely incident through the surface cover layer 11, the ratio of sound capable of penetrating an upper part (a side in contact with the joining layer) of the back-surface layer 13 arranged directly below the joining layer 12 with a decreased area, increases, and a part of the effect of the porous type sound absorbing mechanism of the back-surface layer 13 becomes hardly suppressed. As a result, it is considered that the sound absorption coefficient can be increased overall. As described above, when a coated pressure-sensitive adhesive or double-sided adhesive tape is used as the joining material, the joining layer 12 does not excessively constrain the surface cover layer 11 and the back-surface layer 13, so that it can pass sound waves to some extent. It is therefore considered that the suppression by the porous type sound absorbing mechanism is more reduced and it becomes easy to secure the sound absorption coefficient with a certain level.

Describing in more detail the second invention, even if the total joint area percentage is identical, by arranging one or more regional areas, each being composed of a plurality of joining layers having a predetermined arrangement style on at least a part of the contact surface between the surface cover layer and the back-surface layer, for example, as shown in FIGS. 5, 6, 10, 15, and 16, the arrangement style of joining layers in regional area other than the above regional area is diversified, and the sound absorption characteristics can be controlled after securing the sound absorption coefficient with a certain level. In particular, if there is a regional area composed of a plurality of joining layers is not arranged on the contact surface between the surface cover layer and the back-surface layer, by arranging a regional area composed of one joining layer which has a larger area than the joining layers on at least apart of the regional area, the sound absorption peak frequency can be shifted depending on the size of the area of the joining layer. For example, by increasing the area of the joining layer, the sound absorption peak frequency can be shifted to the lower frequency side or the sound absorption coefficient in the low frequency range can be increased. In addition, the number of openings 14 formed between the joining layers and their arrangement balance, that is, whether the openings 14 are formed/arranged evenly or unevenly over the soundproof material is adjusted, thereby making it possible to control the level of the sound absorption coefficient frequency mainly in the medium to high frequency ranges. For example, when the total joint area percentage of the joining layers is constant, as the individual areas of the joining layers increase, the number of openings 14 formed decreases, and the non-uniformity of the arrangement of the openings 14 tends to increase (becomes unbalanced). Therefore, the sound absorption coefficient in the medium to high frequency ranges decreases, whereas the sound absorption coefficient in the low frequency range modestly increases. As a result, the sound absorption coefficient of the soundproof material in the low to high frequency ranges can be leveled after securing the sound absorption coefficient with a certain level. If the sound absorption coefficient in the medium to high frequency ranges is desired to be secured to some extent, the number of the openings 14 formed is increased, and the areas and arrangement style of the joining layers are adjusted in each regional area so as to lead to cancel the non-uniformity of the arrangement.

The mechanism of achieving the above effect can be presumed basically in the same manner as in the first invention. That is, in the contact surface between surface cover layer and back-surface layer of the soundproof material structure of the present invention, which has the porous type sound absorbing mechanism, resonance type sound absorbing mechanism, and membrane-oscillation-type sound absorbing mechanism, changing the arrangement style of the joining layers for each regional area, in other words means changing the balance of the above three sound absorbing mechanisms. Without changing the total joint area percentage of the joining layers, by arranging one or more regional areas each being composed of a plurality of joining layers having a predetermined arrangement style on at least a part of the contact surface between the surface cover layer and the back-surface layer, the arrangement style of the joining layers in regional areas other than the above regional area can be diversified. Therefore, by the mechanism described in the first invention, the degree of influence of the effects of the three sound absorbing mechanisms can be adjusted depending on the total arrangement style of the joining layers. For example, on regional areas other than the regional area composed a plurality of joining layers having a predetermined arrangement style, if a regional area with an increased area of the joining layers is arranged, the influence of the effect of the membrane-oscillation-type sound absorbing mechanism due to the joint interface is strongly added and therefore, the sound absorption peak frequency of the overall soundproof material can be shifted to the lower frequency side or the sound absorption coefficient in the low frequency range can be increased. Furthermore, in this case, in the contact surface between the surface cover layer and the back-surface layer, by controlling the total number of openings 14 formed, and the arrangement balance while also adjusting the areas of the joining layers in other regional areas, the degree of influence of the effects of the porous type sound absorbing mechanism and the resonance type sound absorbing mechanism can be adjusted. Therefore, the sound absorption coefficient level in the medium to high frequency ranges can be adjusted. Without changing the total joint area percentage of the joining layers, arranging one or more regional areas each being composed of a plurality of joining layers having a predetermined arrangement style on at least a part of the contact surface between the surface cover layer and the back-surface layer as a whole decreases the number of air-permeable openings 14 formed between the joining layers making it difficult to form and arrange openings 14 evenly over the soundproof material. Therefore, in the case of measurement assuming random incident sound such as the reverberation room method sound absorption coefficient, as for sound obliquely incident through the surface cover layer 11, particularly, the ratio of sound capable of penetrating an upper part (a side in contact with the joining layer) of the back-surface layer 13 arranged directly below the joining layer 12 with an increased area decreases, and a part of the effect of the porous type sound absorbing mechanism of the back-surface layer 13 is suppressed. As a result, it is considered that the sound absorption coefficient in the medium to high frequency ranges can be decreased overall. Conversely, if the number of air-permeable openings formed between the joining layers is increased, and the arrangement style of the joining layers is adjusted to make it easy to form and arrange the openings 14 evenly over the entire soundproof material, a part of the effect of the porous type sound absorbing mechanism of the back-surface layer 13 becomes difficult to be suppressed. As a result, it is considered that the sound absorption coefficient in the medium to high frequency ranges can be increased overall. Meanwhile, as described above, when a coated pressure-sensitive adhesive or double-sided adhesive tape is used as the joining material, the joining layer 12 does not excessively constrain the surface cover layer 11 and the back-surface layer 13, so that it can pass sound waves to same extent. Therefore, it is considered that suppression by the porous type sound absorbing mechanism is more reduced and it becomes easy to secure the sound absorption coefficient with a certain level.

As a result of the above, it is presumed that the soundproof material 10 used in the present invention has achieved the effect of controlling the sound absorption characteristics of the soundproof material without changing the total joint area percentage of the joining layers 12 composed of a joining material such as a pressure sensitive adhesive tape, in other words without changing the weight and total thickness of the soundproof material, by adjusting the areas of the individual joining layers, the number of air-permeable openings 14 formed, and the arrangement balance of the openings 14 as needed in the contact surface between the surface cover layer 11 and the back-surface layer 13.

In the soundproof material 10 used in the present invention, for example, when it is necessary to increase the sound absorption coefficient in the low frequency direction depending on the situation, the total joint area percentage is in the range of less than 100% with respect to the entire contact surface between the cover layer 11 and the back-surface layer 13, and preferably in the range of 50 to 95%. If the total joint area percentage is less than 50%, the contribution of the effect of the membrane-oscillation-type sound absorbing mechanism is reduced, and therefore the effect of increasing the sound absorption coefficient in the low to medium frequency direction may become insufficient. Next, when the leveling of the sound absorption coefficient is conducted depending on the situation, the total joint area percentage is in the range of less than 100% with respect to the entire contact surface between the cover layer 11 and the back-surface layer 13, and preferably in the range of 50 to 95%. If the total joint area percentage is less than 50%, it may be difficult to make the arrangement balance of the openings 14 of the joining layers uneven (unbalanced) with respect to the entire contact surface between the surface cover layer and the back-surface layer. In this case, since it becomes difficult to reduce the sound absorption coefficient in the medium to high frequency ranges, there is a possibility that the leveling of the sound absorption coefficient may become insufficient.

The shape of the joining layer 12 is not particularly limited. For example, it includes a linear shape, a dot shape, a punching sheet shape (a shape with a hole in the sheet), and the like. The joining layer 12 may be single, and may also be formed in plurality. When a plurality of joining layers 12 is formed, it is preferable to form regional areas having a regular arrangement style on the contact surface.

In one preferred embodiment, from the viewpoint of workability and processability, the joining layer 12 has, for example, a her-like shape. “Bar-like” means a linear shape having a predetermined width. When the bar-like joining layers 12 are regularly formed on the contact surface, the plurality of bar-like shaped layers forms a striped pattern. In this case, a regional area with the regular arrangement style referred to as the striped pattern is formed on the contact surface. The striped pattern is a line pattern in which straight lines are arranged in parallel at regular intervals. As a result, the air-permeable opening 14 is formed between two adjacent bar-like shaped layers.

The width of the bar-like shaped layer is appropriately determined in consideration of the size of soundproof material used, the number of bar-like shaped layers, and the like besides the above joint area percentage and the desired sound absorption characteristics, but preferably it is 1 mm or more. If the width of the her-like shaped layer is less than 1 mm, it may be difficult to accurately maintain and process the shape and dimensions. On the other hand, the upper limit of the width of the bar-like shaped layer is not particularly limited as long as the effect of the present invention is not hindered. The distance between the adjacent bar-like shaped layers is appropriately determined in consideration of the size of soundproof material used, the number of bar-like shaped layers and the like, besides the above joint area percentage and the sound absorption characteristics.

The thickness of the joining layer 12 is not particularly limited as long as it does not interfere with the effects of the present invention, but it is preferably in the range of 0.025 to 3 mm. If the thickness of the joining layer 12 is less than 0.025 mm, the sound absorption coefficient of the soundproof material 10 may overall decrease, or the joining strength between the surface cover layer 11 and the back-surface layer 13 may decrease. On the other hand, if the thickness of the joining layer exceeds 3 mm, when the joint area is large, the sound absorption coefficient in the high frequency range may decrease. Also the thickness and weight of the soundproof material 10 become large, which is inappropriate for thinning and lightening purposes. Furthermore, the density of the joining layer 12 is not particularly limited as long as the effect of the present invention is not hindered, but it is preferably in the range of 1.0 to 1.5 g/cm³ from the viewpoint of lightening.

### <Surface Cover Layer>

The surface cover layer 11 is composed of a fiber material. The fiber material refers to a material whose shape is supported by fibers, which has a space between fibers, and through which gas can pass. The fiber material may include a plurality of kinds of fibers. The fiber material is preferably in the form of a sheet. Non-woven fabrics, woven fabrics and knitting are included in the fiber material here. On the contrary, resin foams or resin film materials are not included in the fiber material here even if they are air-permeable materials.

The average fiber diameter of fibers constituting the fiber material of the surface cover layer 11 is preferably in the range of 1 to 17 μm, and more preferably in the range of 1 to 10 μm. The fiber diameter of fibers constituting the surface cover layer 11 is made to have a structure with small voids, and in order to increase the sound absorption coefficient in the medium to high frequency ranges, it is preferably made small. The fiber diameters of the fibers constituting fiber material may be the sane or different. When the fiber diameters are different, thick fibers having an average fiber diameter of 17 μm or more and fine fibers having an average fiber diameter of less than 1 μm are, for example, mixed so that the average fiber diameter is 1 to 17 μm, and they may be employed as a fiber material. If the average fiber diameter of fibers constituting the fiber material is less than 1 μm, the strength, rigidity, handling easiness and the like may decrease, and furthermore, it may be disadvantageous in terms of the price. On the other hand, if the above average fiber diameter exceeds 17 μm, the sound absorption coefficient below the medium to high frequency ranges may decrease.

The air-permeation volume of the surface cover layer 11 is preferably in the range of 5 to 200 cm³/cm²·sec, and more preferably in the range of 10 to 100 cm/cm²·sec. If the air-permeation volume of the surface cover layer 11 is less than 5 cm³/cm²·sec, the sound absorption coefficient in the medium to high frequency ranges may decrease. On the other hand, if the air-permeation volume of the surface cover layer 11 exceeds 200 cm³/cm²·sec, the sound absorption coefficient below the medium frequency range may decrease.

By respectively setting the average fiber diameter and air-permeation volume of the surface cover layer 11 in the above ranges, it becomes easier for the fiber material of the surface cover layer 11 to have a relatively dense structure, and a sound absorbing effect which is like combining a resonance type sound absorbing mechanism and a porous type sound absorbing mechanism, namely it has the effect of increasing the sound absorption coefficient in the medium to high frequency ranges. As a result, the soundproof material 10 used in the present invention can achieve the effect of expanding the sound-absorbable frequency range in practical usage, even if the thickness is thin. The smaller the average fiber diameter of the surface cover layer 11, the greater the effect it can achieve.

The thickness of the surface cover layer 11 is preferably in the range of 0.01 to 5 mm, and more preferably in the range of 0.05 to 4 mm. The basis weight of the surface cover layer 11 is preferably in the range of 5 to 300 g/m², and more preferably in the range of 15 to 100 g/m². Furthermore, the average apparent density of the surface cover layer 11 is preferably in the range of 0.01 to 1.0 g/cm³, and more preferably in the range of 0.02 to 1.0 g/m³.

By configuring the thickness, average apparent density, and basis weight of the surface cover layer 11 in such a manner, the sound energy of sound waves transmitted through the fiber material can be more efficiently consumed by air friction in a vicinity portion of the entrance of voids, viscous friction with an inner wall of a fiber skeleton part or like that. If the thickness of the surface cover layer 11 is less than 0.01, the average apparent density is less than 0.01 g/cm³, and the basis weight is less than 5 g/m², the strength, rigidity, fiber density, and the like decrease, and the handling easiness and sound absorption effect may decrease. On the other hand, if the thickness of the surface cover layer 11 exceeds 5 mm, the average apparent density exceeds 1.0 g/m³, and the basis weight exceeds 300 g/m², the strength and fiber density increase, but the rigidity is too high, so that cutting easiness and handling easiness may deteriorate. Also, it is inappropriate for thinning and lightening purposes.

In the present embodiment, the fiber material of the surface cover layer 11 is not particularly limited, but it is preferable to use a nonwoven fabric composed of synthetic fibers. Examples of the fibers constituting the non-woven fabric that can be used include thermoplastic synthetic fibers, such as polyolefin-based fibers such as polyethylene, polypropylene and copolymerized polypropylene; polyamide-based fibers such as nylon 6, nylon 66 and copolymerized polyamide; polyester-based fibers such as polyethylene terephthalate, polybutylene terephthalate, copolymerized polyester and aliphatic polyester; acrylic-based fiber; aramid fiber; composite fibers such as a core sheath structure in which the sheath is composed of polyethylene, polypropylene or copolymerized polyester, and the core is composed of polypropylene or polyester, and the like; biodegradable fibers such as polylactic acid, polybutylene succinate and polyethylene succinate, and the like. These fibers may be used alone or in combination of two or more, and may also be used by mixing or laminating modified cross-section fibers such as flat yarns, crimp fibers, divided fibers, and the like. Among these, polyester-based fibers are particularly preferable from the viewpoints of versatility, heat resistance, flame resistance and the like.

A method for producing the fiber material of the surface cover layer 11 is not particularly limited, and it includes conventional, publicly known methods for producing a nonwoven fabric by a wet method, a dry method or direct spin-drawing (spunbond, meltblown, and the like), and the like. Among these, from the viewpoints of the strength of fiber material, handling easiness, and uniformity of voids, for example, a production method for a warp weft orthogonal nonwoven fabric in which warps and wefts are arranged almost mutually orthogonal or a production method for a nonwoven fabric in which warps are oriented in only one direction, or a production method for a nonwoven fabric in which thick fibers and thin fibers are interfiber bonded between the fibers by a binder is preferable, but these are merely one example, and the present invention is not limited thereto.

The warp weft orthogonal nonwoven fabric is produced by first drawing fibers directly spun from the raw material resin, then processing and preparing them into two types of webs in which fibers are arranged in the respective warp and weft directions, then stacking the two types of webs so that the arranged fibers are orthogonal to each other, and joining them by point thermal bonding with thermal embossing. Besides thermal embossing, the method for stacking warp and weft webs include a method of impregnation adhesion with an emulsion, and a method in which short fibers are entwined with a water jet to combine and integrate them. Similarly, a nonwoven fabric which is in a fiber arrangement only in the warp direction can be produced, and this nonwoven fabric may serve as the fiber material. Different from nonwoven fabrics produced by the conventional spunbond method, in the nonwoven fabric produced by such a method in which predrawn ultrafine fibers having an average fiber diameter of several μm are arranged in the respective warp and weft directions or the warp direction. Therefore, the deformation when a load is applied is small and the shape can be maintained, so that secondary processing (roll-to-roll processing) or the like that requires tension can be easily conducted even if it has a low basis weight. The tensile strength of these nonwoven fabrics (according to ASTM D882) is preferably in the range of 20 to 300 N/50 mm in the MD direction.

The non-woven fabric in which thick fibers and thin fibers are interfiber bonded by a binder is produced first, for example, by melt-spinning or wet-spinning fibers having different fiber diameters from the above raw material resin such as polyester, cutting them into flocs having a fiber length of 10 mm or less, preparing a suspension obtained by mixing them with fillers such as the polyvinyl alcohol-based fibers that serve as a binder, and uniformly dispersing them, followed by a usual paper-making method. The fibers having different fiber diameters may be the same material or different materials. When making a sheet, other than the above-mentioned papermaking method that is a wet method, a dry method in which short fibers are sheeted by a card machine and a webber (air-laid method) using an air flow and the like may be used. The fiber arrangement may be either cross or random.

### <Rack-Surface Layer>

The back-surface layer 13 is composed of a porous material with voids interconnected with each other. The porous material with voids interconnected with each other is not limited as long as it is used as the sound absorbing material, but includes felt, a fiber material such as a nonwoven fabric composed of synthetic fibers (including a mixture of synthetic fibers by needle punching or felt made of 100% synthetic fibers), a foam material having open cells and the like.

The above fiber material includes those in which, for example, cotton, wool, wood wool, waste fiber, and the like are processed into a felt shape with a thermosetting resin (generic name: resin felt); synthetic fiber felts such as polyester fiber felts such as polyethylene terephthalate, nylon fiber felt, polyethylene fiber felt, polypropylene fiber felt, acrylic fiber felt, composite fiber felt having a core/sheath structure in which the sheath is composed of polyethylene, polypropylene or copolymerized polyester, and the core is composed of polypropylene or polyester, and the like, and biodegradable fiber felts such as polylactic acid, polybutylene succinate and polyethylene succinate; inorganic fiber felts such as silica-alumina ceramic fiber felt, silica fiber felt, glass wool, and rock wool long fiber. The foam material having open cells includes, for example, polyurethane foam, polyethylene foam, polypropylene foam, phenol foam, melamine foam; those in which rubbers such as nitrile butadiene rubber, chloroprene rubber, styrene rubber, silicone rubber, urethane rubber, EPDM and the like are foamed in interconnected open cells, or those in which after foaming them, they are subjected to crushing processing or the like, and the foam cells are perforated, and formed in interconnected open cells, and the like. Among these, synthetic fiber felt is preferable from the viewpoint of versatility, and polyester fiber felt is more preferable from the viewpoint of heat resistance, flame resistance and the like.

When the fiber material is used as the back-surface layer 13, the average fiber diameter of fibers constituting the fiber material is preferably in the range of 10 to 30 μm. The thickness of the fiber material is preferably in the range of 5 to 15 mm. Further, the basis weight of the fiber material is preferably in the range of 50 to 1500 g/m², more preferably in the range of 100 to 300 g/m², and particularly preferably in the range of 200 to 280 g/m². Furthermore, the average apparent density of the fiber material is preferably in the range of 0.01 to 0.1 g/cm³.

When the foam material having open cells is used as the above back-surface layer 13, the thickness of the foam material is preferably in the range of 5 to 15 mm. The basis weight of the foam material is preferably in the range of 50 to 4500 g/m², more preferably in the range of 100 to 2000 g/m², and particularly preferably in the range of 100 to 1000 g/m². The average apparent density of the foam material is preferably in the range of 0.01 to 0.3 g/cm³.

By configuring the average fiber diameter, thickness, average apparent density, and a basis weight of fibers of the back-surface layer 13 of the above-described fiber material in such a manner, sound waves transmitted without being absorbed by the fiber material of the surface cover layer 11 are efficiently transmitted to the fiber material or the foam material having open cells of the back-surface layer 13, and a part of sound wave energy can be exchanged and consumed as heat energy by friction with a peripheral wall of a skeleton part, viscous resistance, vibration of the skeleton and the like. In the back-surface layer 13, if the average fiber diameter, thickness, average apparent density and basis weight of the fibers are less than the above ranges, the sound absorption coefficient may decrease overall. On the other hand, if the average fiber diameter, thickness, average apparent density and basis weight of the fibers exceed the above ranges, it is inappropriate for thinning and lightening purposes.

The air-permeation volume of the back-surface layer 13 is not particularly limited, but it is preferably equal to or higher than the air-permeation volume of the surface cover layer 11 and specifically, it is preferably in the range of 5 to 1000 cm³/cm²·sec, and more preferably in the range of 100 to 300 cm³/cm²·sec. If the air-permeation volume of the back-surface layer 13 exceeds 1000 cm³/cm²·sec, handling easiness and mechanical strength may deteriorate.

The unit-area flow resistance of the back-surface layer 13 is preferably 0.5×10⁴ to 3.5×10⁴ N·sec/m⁴. If the unit-area flow resistance is in the above range, the effects of the porous type sound absorbing mechanism and the resonance type sound absorbing mechanism can be sufficiently exhibited, so that the sound absorption coefficient in the medium to high frequency ranges can be easily secured at a certain level.

The method for producing the synthetic fiber felt used in the back-surface layer 13 is not particularly limited, and includes conventional, publicly known production methods. Specifically, the above-mentioned synthetic fibers are defibrated and mixed by a dry method (carding method or air-laid method) and formed into layered, laminated felt-like mats by a felt sorter, interlayer stitched by a needle punch method in order to retain the shape of the felt and to prevent layered delamination thereof, thereby being able to obtain synthetic fiber felt. Other than the needle punch method, interlayer stitching and interfiber bonding may be conducted using a chemical bond method, a thermal bond method, a water flow entanglement method, or the like.

The method for producing the foam material having open cells used in the back-surface layer 13 is not particularly limited, and examples thereof include conventional, publicly known production methods. For example, a urethane foam material can be obtained by mixing a polyisocyanate and a polyol with a catalyst, a foaming agent, a foam stabilizer, and the like, and simultaneously conducting a foaming reaction and a resin making reaction. In addition, an open cell polyolefin-based foam material can also be obtained by a method in which a closed-cell type polyolefin-based foam material is produced in advance, on which compression processing is conducted in which the foam material is passed through gaps between two rolls rotating in different directions so as to be compressed, thereby rupturing cell membranes and being formed in interconnected open cells.

### <Soundproof Material>

The soundproof material 10 used in the present invention is obtained by partially joining the surface cover layer 11 to one surface of the back-surface layer 13 by the joining layer 12. The method for joining the surface cover layer 11 and the back-surface layer 13 is preferably a method in which the respective layers are laminated by using a coated pressure-sensitive adhesive or double-sided adhesive tape (including a substrate-less double-sided adhesive tape having no substrate) so as to have a predetermined joint area percentage. Specifically, the joining layer 12 composed of a double-sided adhesive tape slit to a predetermined width (including a substrate-less double-sided tape), a punched double-sided tape, or a sheet in which a pressure-sensitive adhesive is coated in stripes or dots, or the like is laminated or transferred onto either one of the surfaces of the surface cover layer 11 so that the joining layer 12 has a predetermined joint area percentage, and thereafter both the layers may be contact bonded/joined. The contact bonding of the surface cover layer 11 and the back-surface layer 13 can be conducted in an environment at normal temperature without heating. However, if necessary, the contact bonding may be conducted while heating.

The thickness of the soundproof material 10 used in the present invention is preferably in the range of 10 to 30 mm. If the thickness of the soundproof material 10 is less than 10 mm, the sound absorption coefficient may decrease overall. On the other hand, if the thickness of the soundproof material 10 exceeds 30 mm, it is inappropriate for thinning and lightening.

### <Control of Sound Absorption Characteristics>

In the soundproof material used in the present invention, the sound absorption peak frequency of the soundproof material is shifted to the lower frequency side when the individual areas of the joining layer are increased. Also, in the soundproof material used in the present invention, the sound absorption peak frequency of the soundproof material is shifted to the higher frequency side when the individual areas of joining layer are reduced.

In the soundproof material used in the present invention, when the individual areas of the joining layer are increased, the sound absorption coefficient on the higher frequency range side of the sound absorption peak frequency of the soundproof material decreases, and the sound absorption coefficient on the lower frequency range side of the sound absorption peak frequency increases. Also, in the soundproof material used in the present invention, when the individual areas of the joining layer are reduced, the sound absorption coefficient on the higher frequency range side of the sound absorption peak frequency of the soundproof material increases, and the sound absorption coefficient on the lower frequency range side of the sound absorption peak frequency decreases.

In the soundproof material used in the present invention, it is not necessary to change the total joint area percentage or the constituent materials in order to reduce or increase the sound absorption peak frequency or sound absorption coefficient. If the sound absorption peak frequency of the soundproof material is shifted, or the sound absorption coefficient of the soundproof material is changed, for example, the total joint area percentage may be fixed to a predetermined value of less than 100%, preferably to one value selected from the range of 50 to 95%.

However, if the function of changing the sound absorption characteristics of the soundproof material is not substantially prevented, a constituent material may be added to the soundproof material used in the present invention, or the constituent material of the said soundproof material may be changed.

In the soundproof material used in the present invention, for example, when a plurality of soundproof materials, the joining layers of which have different areas, are arranged in parallel, it is understood that the sound absorption characteristics of each soundproof material are expressed depending on the area, resulting in fused sound absorption characteristics. Then, the soundproof material used in the present invention can change the sound absorption coefficient in the desired frequency range, for example, by forming partially a joining layer, forming overall or partially a regional area composed of a plurality of joining layers, or combining a plurality of regional areas, each regional area composed of a plurality of joining layers, on the contact surface.

As a result, the soundproof material used in the present invention can easily design and realize the optimum sound absorption coefficient in the low to high frequency ranges depending on various usages of the soundproof material.

### EXAMPLES

The present invention will be described in more detail with reference to the following examples, but the present invention is not limited thereto. The characteristic values of Examples and Comparative Examples were measured by the following methods.

### (1) Reverberation Room Method Sound Absorption Coefficient

A reverberation room method sound absorption coefficient test using an impulse response conforming to ISO354 was conducted. The reverberation roam method sound absorption coefficient sound absorption coefficient is a sound absorption coefficient calculated from each reverberation time obtained from an attenuation curve of reverberation sound of a radiated sound source in the state with and without a test body in a reverberation room, and is calculated by the following formula (1):

α₆=(55.3 V/(c·S))·(1/T₂−1/T₁) (1)

where V is the volume of the reverberation room [m³], which is 8.9 m³ in this evaluation test. C is the sound speed [m/s]. S is the surface area [m²] of a test body, which was set to 1 m² (1 m×1 m) in this evaluation test. T₁ is the reverberation time of the reverberation room before placing the test body, and T₂ is the reverberation time of the reverberation roan after placing the test body. The calculated sound absorption coefficient αₛ indicates the ratio of the energy of unreflected sound to the energy of sound incident on the test body, and the larger the αₛ, the easier it is to absorb the sound.

### (2) Average Particle Diameter

A photograph with a magnification of 500 times was taken with a microscope, 100 fibers were arbitrarily selected, the average value was calculated, and one digit after the decimal point was rounded off to obtain the average fiber diameter.

### (3) Air Permeation Volume

It was measured by a Frazier type air permeability tester in accordance with JIS L 1096. For the Frazier type air permeation tester, DAP-360 (product model number) manufactured by DAIEI KAGAKU SEIKI MFG. co., ltd. was used. The measurement conditions were a differential pressure of 125 Pa, and a measurement hole diameter of 70 mm. Three or more points were measured, and it was calculated by their average.

### (4) Thicknesses of Surface Cover Layer and Back-Surface Layer

They were measured according to JIS-L-1913-B method. The loads were 20 kPa in the case of the surface cover layer, and 0.02 kPa in the case of the back-surface layer. Three or more points were measured, and they were calculated by their average values.

### (5) Basis Weights of Surface Cover Layer and Back-Surface Layer

They were measured according to JIS-L-1913.

### (6) Thickness of Joining Layer

By a dial gauge, three or more points were measured with a meter diameter of 10 mm, at a final pressure of 0.8 N, and it was calculated by their average value.

### (7) Storage Elastic Modulus (G′) of Joining Material

For the material used for the joining layer, a sample with a thickness of 500 μm was prepared, the dynamic viscoelasticity was measured using a viscoelasticity measuring device DMA6100 (product name) manufactured by Hitachi High-Tech Science Corporation, and the storage elastic modulus was calculated. The measurement conditions were, while applying a shear strain at a frequency of 1 Hz, the temperature was changed from −80° C. to 80° C. at a heating rate of 5° C./min, the storage elastic modulus (G′) was measured, and the value at 25° C. was calculated.

### Example 1

### (Surface Cover Layer)

As the surface cover layer, a polyester fiber material having an average fiber diameter of 3 μm, an air permeation volume of 21 cm³/cm²·sec, a basis weight of 20 g/m², an average apparent density of 0.33 g/cm³ and a thickness of 0.06 mm was prepared (size: 1000 mm×1000 mm). In this polyester fiber material, fibers were arranged in a vertical direction.

### (Back-Surface Layer)

As the back-surface layer, a polyester fiber felt having an average fiber diameter of 19 μm, an air permeation volume of 165 cm³/cm²·sec, a basis weight of 200 g/m², an average apparent density of 0.02 g/cm³, a unit area flow resistance of 1.0×10⁴ N·sec/m⁴ and a thickness of 10 mm was prepared (size: 1000 mm×1000 mm).

### (Joining Method)

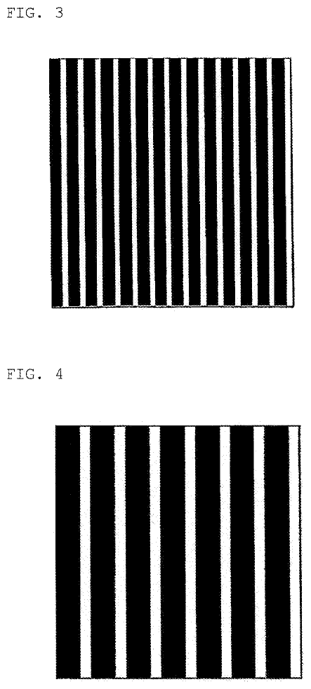

A double-sided pressure-sensitive adhesive tape “NO. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 10 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 2. The joining layer was formed by repeating 10 times a basic joining pattern made so that there were six joining patterns of the line/space=10 mm/4 mm and one joining pattern of the line/space=10 mm/6 mm from the left end of the surface cover layer. The pattern has the same meaning as the regular arrangement style.

This joining pattern is expressed as a set value in the width direction in the invention of the present application: [(line width of 10 mm/space width of 4 mm)×six times+(line width of 10 mm/space width of 6 mm)×one time]×ten times=1000 mm.

Next, after peeling off the release paper of the pressure-sensitive adhesive tape arranged and laminated onto the surface cover layer, the surface cover layer was spread and placed on it, and both the layers were joined by pressure bonding in a normal temperature environment to obtain a soundproof material (1000 mm×1000 mm). In the reverberation roam method sound absorption coefficient test, the measurement was conducted with a size of 1000 mm×1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 70% when the area (1 m²) of the surface where the surface cover layer and the back-surface layer faced each other was 100%.

### Example 2

A soundproof material was obtained in the same manner as in Example 1 except that the joining method was as follows.

### (Joining Method)

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 50 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 3. The joining layer was formed by repeating two times a basic joining pattern made so that there were five joining patterns of the line/space=50 mm/22 mm and two joining patterns of the line/space=50 mm/20 mm from the left end of the surface cover layer.

This joining pattern is expressed as a set value in the width direction in the present invention: [(line width of 50 mm/space width of 22 mm)×five times+(line width of 50 mm/space width of 20 mm)×two times]×two times=1000 mm.

The total thickness of the soundproof material obtained was 10.6 mm. In addition, in the measurement sample 1000 mm×1000 mm of the reverberation roam method sound absorption coefficient, the total joint area percentage of the joining layers formed by the pressure sensitive adhesive tapes was 70%.

### Example 3

A soundproof material was obtained in the same manner as in Example 1 except that the joining method was as follows.

### (Joining Method)

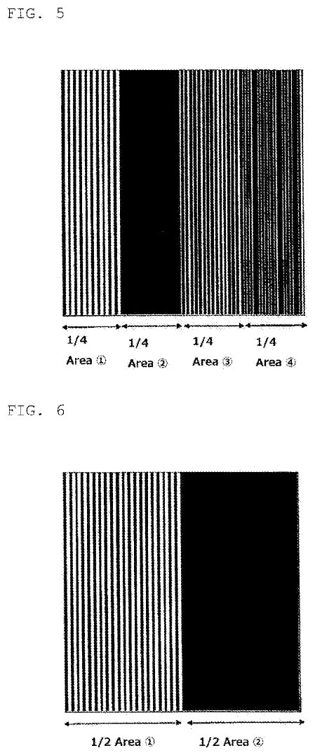

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 100 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 4. The joining layer was formed by repeating one time a basic joining pattern made so that there were six joining patterns of the line/space=100 mm/43 mm and one joining pattern of the line/space=100 mm/42 mm from the left end of the surface cover layer.

This joining pattern is expressed as a set value in the width direction in the invention of the present application: [(line width of 100 mm/space width of 43 mm)×six times+(line with of 100 mm/space width of 42 mm)×one time]×one time=1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 70%.

### Example 4

A soundproof material was obtained in the same manner as in Example 1 except that the joining method was as follows.

### (Joining Method)

A double-sided pressure-sensitive adhesive tape “No. 5938 Sir Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into bar-like shapes with widths of 10 mm and 250 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 5. The surface cover layer was equally divided in the width direction into four portions, which served as a ¼ area (1), a ¼ area (2), a ¼ area (3), and a ¼ area (4) from the left end. First, in the ¼ area (1), a joining layer was formed by repeating ten times a basic joining pattern of a line/a space=10 mm/15 mm from the left end. Next, in the ¼ area (2), a joining layer was formed by repeating one time a basic joining pattern of a line/a space=250 mm/0 mm from the left end. Next, in the ¼ area (3), a joining layer was formed by repeating five times a basic joining pattern made so that there were two joining patterns of a line/a space=10 mm/6 mm, and one joining pattern of a line/a space=10 mm/8 mm from the left end. Finally, in the ¼ area (4), a joining layer was formed by repeating five times a basic joining pattern made so that there were three joining patterns of a line/a space=10 mm/2 mm, and one joining pattern of a line/a space=10 mm/4 mm from the left end.

This joining pattern is expressed as a set value in the width direction in the invention of the present application:

¼ Area (1) (line width of 10 mm/space width of 15 mm)×ten times=250 mm.

¼ Area (2) (line width of 250 mm/space width of 0 mm)×one time=250 mm.

¼ Area (3) [(line width of 10 mm/space width of 6 mm)×two times+(line width of 10 mm/space width of 8 mm×one time)]×five times=250 mm.

¼ Area (4) [(line width of 10 mm/space width of 2 mm)×three times+(line width of 10 mm/space width of 4 mm×one time)]×five times=250 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 70%.

### Example 5

A soundproof material was obtained in the same manner as in Example 1 except that the joining method was as follows.

### (Joining Method)

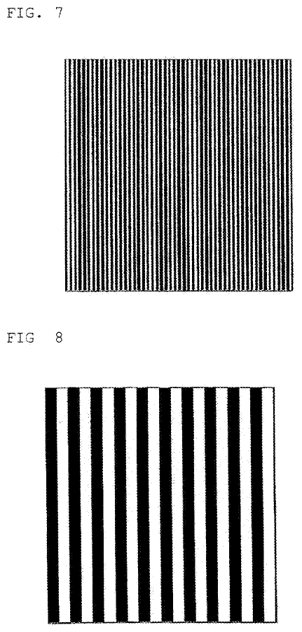

A double-sided pressure-sensitive adhesive tape “No. 5938 Super Butyl Tape” (trade name, substrate: polyethylene net, pressure-sensitive adhesive tape-thickness: 0.5 μm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with widths of 10 mm and 500 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 6. The surface cover layer was equally divided in the width direction into two portions, which served as a ½ area (1), and a ½ area (2) from the left end. First, in the ½ area (1), a joining layer was formed by repeating twenty times a basic joining pattern of a line/a space=10 mm/15 mm from the left end. Next, in the ½ area (2), a joining layer was formed by repeating one time a basic joining pattern of a line/a space=500 mm/0 mm from the left end.

This joining pattern is expressed as a set value in the width direction in the invention of the present application:

½ Area (1) (line width of 10 mm/space width of 15 mm)×twenty times=500 mm.

½ Area (2) (line width of 500 mm/space width of 0 mm)×one time=500 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 70%.

### Example 6

A soundproof material was obtained in the same manner as in Example 1 except that the joining method was as follows.

### (Joining Method)

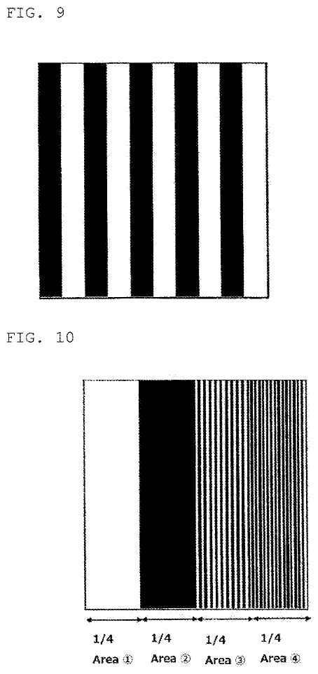

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into bar-like shape with a width of 10 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 7. The joining layer was formed by repeating fifty times a basic joining pattern of the line/space=10 mm/10 mm.

This joining pattern is expressed as a set value in the width direction: [(line width of 10 mm/space width of 10 mm)×fifty times=1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 50%.

### Example 7

A soundproof material was obtained in the same manner as in Example 1 except that the joining method was as follows.

### (Joining Method)

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 50 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 8. The joining layer was formed by repeating 10 times a basic joining pattern of the line/space=50 mm/50 mm.

This joining pattern is expressed as a set value in the width direction in the invention of the present application: (line width of 50 mm/space width of 50 mm)×ten times=1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 50%.

### Example 8

A soundproof material was obtained in the same manner as in Example 1 except that the joining method was as follows.

### (Joining Method)

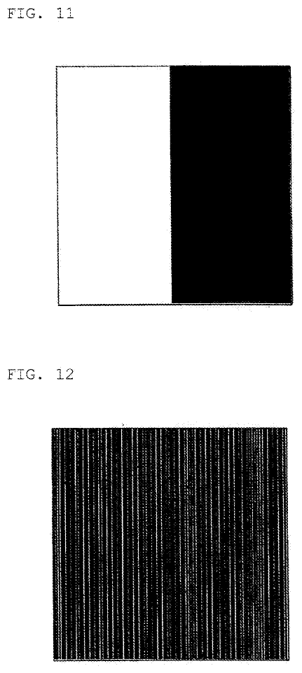

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 100 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 9. The joining layer was formed by repeating five times a basic joining pattern of the line/space=100 mm/100 mm.

This joining pattern is expressed as a set value in the width direction in the invention of the present application: (line width of 100 mm/space width of 100 mm)×five times=1000 mm.

The total thickness of the soundproof material obtained was 10.6 mm. In addition, in the measurement sample 1000 mm×1000 mm of the reverberation roam method sound absorption coefficient, the total joint area percentage of the joining layers formed by the pressure sensitive adhesive tapes was 50%.

### Example 9

A soundproof material was obtained in the same manner as in Example 1 except that the joining method was as follows.

### (Joining Method)

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into bar-like shapes with widths of 10 mm and 250 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 10. The surface cover layer was equally divided in the width direction into four portions, which served as a ¼ area (1), a ¼ area (2), a ¼ area (3), and a ¼ area (4) from the left end. First, in the ¼ area (1), a joining layer was formed by repeating one time a basic joining pattern of a line/a space=0 mm/250 mm from the left end. Next, in the ¼ area (2), a joining layer was formed by repeating one time a basic joining pattern of a line/a space=250 mm/0 mm from the left end. Next, in the ¼ area (3), a joining layer was formed by repeating ten times a basic joining pattern of a line/a space=10 mm/15 mm from the left end. Finally, in the ¼ area (4), a joining layer was formed by repeating five times a basic joining pattern made so that there were two joining patterns of a line/a space=10 mm/6 mm, and one joining pattern of a line/a space=10 mm/8 mm from the left end.

This joining pattern is expressed as a set value in the width direction in the invention of the present application:

¼ Area (1) (line width of 0 mm/space width of 250 mm)×one time=250 mm.

¼ Area (2) (line width of 250 mm/space width of 0 mm)×one time=250 mm.

¼ Area (3) (line width of 10 mm/space width of 15 mm)×ten times=250 mm.

¼ Area (4) (line width of 10 mm/space width of 6 mm)×two times+(line width of 10 mm/space width of 8 mm×one time)]×five times=250 mm.

The total thickness of the soundproof material obtained was 10.6 mm. In addition, in the measurement sample 1000 mm×1000 mm of the reverberation roam method sound absorption coefficient, the total joint area percentage of the joining layers formed by the pressure sensitive adhesive tapes was 50%.

### Example 10

A soundproof material was obtained in the same manner as in Example 1 except that the joining method was as follows.

### (Joining Method)

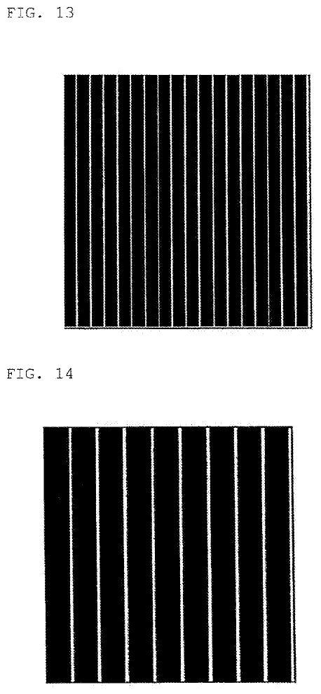

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure sensitive adhesive: 3.5×10⁵ Pa) manufactured by Maxell Holdings, Ltd., which used a butyl rubber-based pressure-sensitive adhesive, was cut into a her-like shape with a width of 500 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 11. The surface cover layer was equally divided in the width direction into two portions, which served as a ½ area (1), and a ½ area (2) from the left end. First, in the ½ area (1), a joining layer was formed by repeating one time a basic joining pattern of a line/a space=0 mm/500 mm from the left end. Next, in the ½ area (2), a joining layer was formed by repeating one time a basic joining pattern of a line/a space=500 mm/0 mm from the left end.

This joining pattern is expressed as a set value in the width direction in the invention of the present application:

½ Area (1) (line width of 0 mm/space width of 500 mm)×one time=500 mm.

½ Area (2) (line width of 500 mm/space width of 0 mm)×one time=500 mm.

The total thickness of the soundproof material obtained was 10.6 mm. In addition, in the measurement sample 1000 mm×1000 mm of the reverberation room method sound absorption coefficient, the total joint area percentage of the joining layer formed by the pressure sensitive adhesive tape was 50%.

### Example 11

A soundproof material was obtained in the same manner as in Example 1 except that the joining method was as follows.

### (Joining Method)

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 10 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 12. The joining layer was formed by repeating 10 times a basic joining pattern made so that there were eight joining patterns of the line/space=10 mm/1 mm and one joining pattern of the line/space=10 mm/2 mm from the left end of the surface cover layer.

This joining pattern is expressed as a set value in the width direction in the invention of the present application: [(line width of 10 mm/space width of 1 mm)×eight times (line width of 10 mm/space width of 2 mm)×one time]×ten times=1000 mm.

The total thickness of the soundproof material obtained was 10.6 mm. In addition, in the measurement sample 1000 mm×1000 mm of the reverberation roam method sound absorption coefficient, the total joint area percentage of the joining layers formed by the pressure sensitive adhesive tapes was 90%.

### Example 12

A soundproof material was obtained in the same manner as in Example 1 except that the joining method was as follows.

### (Joining Method)

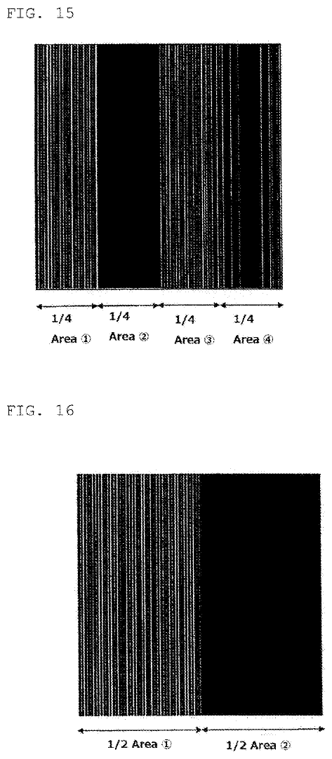

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 50 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 13. The joining layer was formed by repeating 2 times a basic joining pattern made so that there were five joining patterns of the line/space=50 mm/6 mm and four joining patterns of the line/space=50 mm/5 mm from the left end of the surface cover layer.

This joining pattern is expressed as a set value in the width direction in the invention of the present application: [(line width of 50 mm/space width of 6 mm)×five times+(line width of 50 mm/space width of 5 mm)×four times]×two times=1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 90%.

### Example 13

A soundproof material was obtained in the same manner as in Example 1 except that the joining method was as follows.

### (Joining Method)

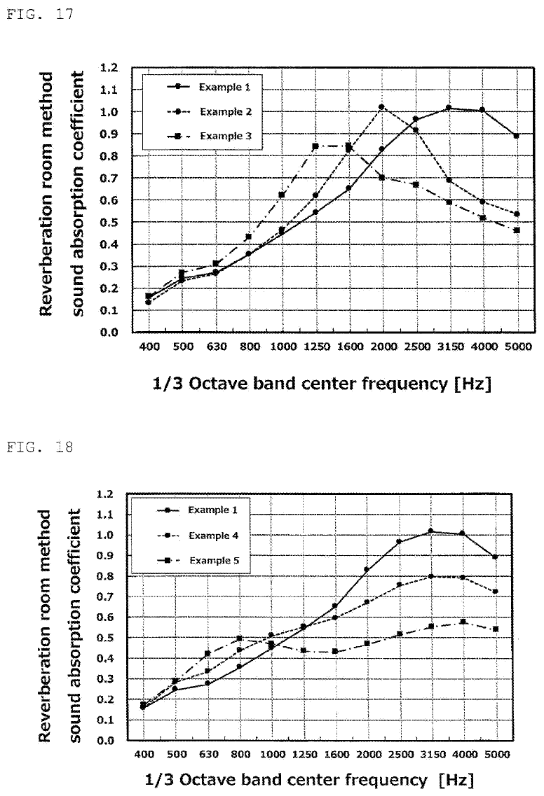

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into a bar-like shape with a width of 100 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate. The detailed arrangement method is as shown in FIG. 14. The joining layer was formed by repeating one time a basic joining pattern made so that there were eight joining patterns of the line/space=100 mm/11 mm and one joining pattern of the line/space=100 mm/12 mm from the left end of the surface cover layer.

This joining pattern is expressed as a set value in the width direction in the invention of the present application: [(line width of 100 mm/space width of 11 mm)×eight times+(line width of 100 mm/space width of 12 mm)×one time]×one time=1000 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 90%.

### Example 14

A soundproof material was obtained in the same manner as in Example 1 except that the joining method was as follows.

### (Joining Method)

A double-sided pressure-sensitive adhesive tape “No. 5938 Super Butyl Tape” (trade name, substrate: polyethylene net, pressure-sensitive adhesive tape-thickness: 0.5 mm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into bar-like shapes with widths of 10 mm and 250 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 15. The surface cover layer was equally divided in the width direction into four portions, which served as a ¼ area (1), a ¼ area (2), a ¼ area (3), and a ¼ area (4) from the left end. First, in the ¼ area (1), a joining layer was formed by repeating five times a basic joining pattern made so that there were three joining patterns of a line/a space=10 mm/2 mm, and one joining pattern of a line/a space=10 mm/4 mm from the left end. Next, in the ¼ area (2), a joining layer was formed by repeating one time a basic joining pattern of a line/a space=250 mm/0 mm from the left end. Next, in the ¼ area (3), a joining layer was formed by repeating one time a basic joining pattern made so that there were 15 joining patterns of a line/a space=10 mm/1.8 mm, three joining patterns of a line/a space=7.5 mm/1.5 mm, and four joining patterns of a line/a space=10 mm/1.5 mm from the left end. Finally, in the ¼ area (4), a joining layer was formed by repeating one time a basic joining pattern made so that there were ten joining patterns of a line/a space=10 mm/0.5 nm, five joining patterns of a line/a space=9.5 mm/0.6 μm, and nine joining patterns of a line/a space=10 mm/0.5 mm from the left end.

This joining pattern is expressed as a set value in the width direction in the invention of the present application:

¼ Area (1) [(line width of 10 mm/space width of 2 mm)×three times+(line width of 10 mm/space width of 4 mm)]×five times=250 mm.

¼ Area (2) (line width of 250 mm/space width of 0 mm)×one time=250 mm.

¼ Area (3) [(line width of 10 mm/space width of 1.8 mm)×15 times+(line width of 7.5 mm/space width of 1.5 mm)×three times+(line width of 10 mm/space width of 1.5 mm)×four times]×one time=250 mm.

¼ Area (4) [(line width of 10 mm/space width of 0.5 mm)×ten times+(line width of 9.5 mm/space width of 0.6 mm)×five times+(line width of 10 mm/space width of 0.5 mm)×nine times]×one time=250 mm.

The total thickness of the soundproof material obtained was 10.6 mm. In addition, in the measurement sample 1000 mm×1000 mm of the reverberation room method sound absorption coefficient, the total joint area percentage of the joining layers formed by the pressure sensitive adhesive tapes was 90%.

### Example 15

A soundproof material was obtained in the same manner as in Example 1 except that the joining method was as follows.

### (Joining Method)

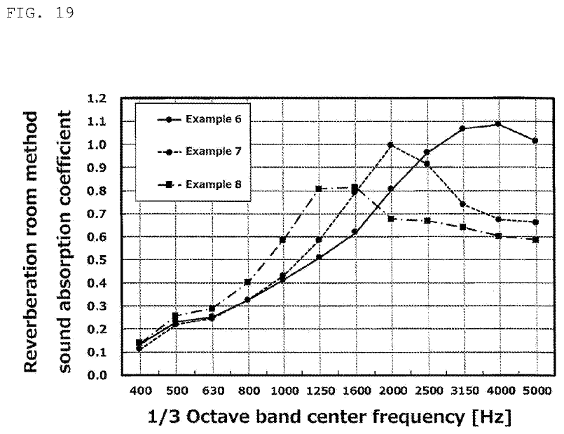

A double-sided pressure-sensitive adhesive tape “No. 5938 Super Butyl Tape” (trade name, substrate: polyethylene net, pressure-sensitive adhesive tape-thickness: 0.5 μm, single-sided separator, storage elastic modulus of pressure-sensitive adhesive: 3.5×10⁵ Pa) manufactured by Maxell Holdings, Ltd., which used a butyl rubber-based pressure-sensitive adhesive, was cut into bar-like shapes with widths of 10 mm and 500 mm. The surface cover layer was spread, and the bar-like shaped pressure-sensitive adhesive tapes were arranged in parallel and laminated onto the surface thereof so that a line (a joined portion of the pressure-sensitive adhesive tape)/a space (an opening)/the line/the space were alternate for each area. The detailed arrangement method is as shown in FIG. 16. The surface cover layer was equally divided in the width direction into two portions, which served as a ½ area (1), and a ½ area (2) from the left end. First, in the ½ area (1), a joining layer was formed by repeating 40 times a basic joining pattern of a line/a space=10 mm/2.5 mm from the left end. Next, in the ½ area (2), a joining layer was formed by repeating one time a basic joining pattern of a line/a space=500 mm/0 mm from the left end.

This joining pattern is expressed as a set value in the width direction in the invention of the present application:

½ Area (1) (line width of 10 mm/space width of 2.5 mm)×40 times=500 mm.

½ Area (2) (line width of 500 mm/space width of 0 mm)×one time=500 mm.

The total thickness of the soundproof material obtained was 10.6 mm. In addition, in the measurement sample 1000 mm×1000 mm of the reverberation roam method sound absorption coefficient, the total joint area percentage of the joining layers formed by the pressure sensitive adhesive tapes was 90%.

### Example 16

A soundproof material was obtained in the same manner as in Example 1 except that the surface cover layer was as follows.

### (Surface Cover Layer)

As the surface cover layer, a polyester fiber material having an average fiber diameter of 17 μm, an air permeation volume of 197 cm³/cm²·sec, a basis weight of 85 g/m², an average apparent density of 0.14 g/cm³ and a thickness of 0.6 mm was prepared (size: 1000 mm×1000 mm). In this polyester fiber material, fibers were random.

The total thickness of the soundproof material obtained was 11.1 mm. In addition, in the measurement sample 1000 mm×1000 mm of the reverberation roam method sound absorption coefficient, the total joint area percentage of the joining layers formed by the pressure sensitive adhesive tapes was 70%.

### Example 17

A soundproof material was obtained in the same manner as in Example 2 except that the surface cover layer was as follows.

### (Surface Cover Layer)

As the surface cover layer, a polyester fiber material having an average fiber diameter of 17 μm, an air permeation volume of 197 cm³/cm²·sec, a basis weight of 85 g/m², an average apparent density of 0.14 g/cm³ and a thickness of 0.6 mm was prepared (size: 1000 mm×1000 mm). In this polyester fiber material, fibers were random.

The total thickness of the soundproof material obtained was 11.1 mm. In addition, in the measurement sample 1000 mm×1000 mm of the reverberation room method sound absorption coefficient, the total joint area percentage of the joining layers formed by the pressure sensitive adhesive tapes was 70%.

### Example 18

A soundproof material was obtained in the same manner as in Example 4 except that the surface cover layer was as follows.

### (Surface Cover Layer)

As the surface cover layer, a polyester fiber material having an average fiber diameter of 17 μm, an air permeation volume of 197 cm³/cm²·sec, a basis weight of 85 g/m², an average apparent density of 0.14 g/cm³ and a thickness of 0.6 mm was prepared (size: 1000 mm×1000 mm). In this polyester fiber material, fibers were random.

The total thickness of the soundproof material obtained was 11.1 mm. In addition, in the measurement sample 1000 mm×1000 mm of the reverberation roam method sound absorption coefficient, the total joint area percentage of the joining layers formed by the pressure sensitive adhesive tapes was 70%.

The joining patterns of the joining layer are shown in Tables 1 to 4.

Tables 5 to 8 show the sound absorption coefficients for each ⅓ octave band center frequency of the obtained soundproof materials. The values of the sound absorption coefficients in Examples 1 to 18 are actually measured values based on the results of the reverberation room method sound absorption coefficient test conducted.

TABLE 1

| | | | Example 1 | Example 2 | Example 3 | Example 4 | | | | Example 5 | |
|---|---|---|---|---|---|---|---|---|---|---|---|
| Joining | Total contact area | (%) | 70 | | | | | | | | |
| pattern of | percentage | | | | | | | | | | |
| joining | Contact area | Area No. | — | — | — | ¼ Area(1) | ¼ Area(2) | ¼ Area(3) | ¼ Area(4) | ½ Area(1) | ½ Area(2) |
| layer | percentage for | (%) | — | — | — | 40 | 100 | 60 | 80 | 40 | 100 |
| | each area | | | | | | | | | | |
| | Line width of | (mm) | 10 | 50 | 100 | 10 | 250 | 10 | 10 | 10 | 500 |
| | joining layer | | | | | | | | | | |
| | Space width | (mm) | 4, 6 | 22, 20 | 43, 42 | 15 | 0 | 6, 8 | 2, 4 | 15 | 0 |

| | | | | | |
|---|---|---|---|---|---|
| Image view of joining pattern | Pattern 1 | Pattern 2 | Pattern 3 | Pattern 4 | Pattern 5 |

TABLE 2

| | | | Example 6 | Example 7 | Example 8 | Example 9 | | | | Example 10 | |
|---|---|---|---|---|---|---|---|---|---|---|---|
| Joining | Total contact area | (%) | 50 | | | | | | | | |
| pattern of | percentage | | | | | | | | | | |
| joining | Contact area | Area No. | — | — | — | ¼ Area(1) | ¼ Area(2) | ¼ Area(3) | ¼ Area(4) | — | — |
| layer | percentage for | (%) | — | — | — | 0 | 100 | 40 | 60 | 0 | 100 |
| | each area | | | | | | | | | | |
| | Line width of | (mm) | 10 | 50 | 100 | 0 | 250 | 10 | 10 | 0 | 500 |
| | joining layer | | | | | | | | | | |
| | Space width | (mm) | 10 | 50 | 100 | 250 | 0 | 15 | 6, 8 | 500 | 0 |

| | | | | | |
|---|---|---|---|---|---|
| Image view of joining pattern | Pattern 6 | Pattern 7 | Pattern 8 | Pattern 9 | Pattern 10 |

TABLE 3

| | | | Exam- | Exam- | Exam- | Exam- | | | | Exam- | |
|---|---|---|---|---|---|---|---|---|---|---|---|
| | | | ple 11 | ple 12 | ple 13 | ple 14 | | | | ple 15 | |
| Joining | Total contact | (%) | 90 | | | | | | | | |
| pattern of | area percentage | | | | | | | | | | |
| joining | Contact area | Area | — | — | — | ¼ Area(1) | ¼ Area(2) | ¼ Area(3) | ¼ Area(4) | ½ Area(5) | ½ Area(6) |
| layer | percentage for | No. | | | | | | | | | |
| | each area | (%) | — | — | — | 80 | 100 | 85 | 95 | 80 | 100 |
| | Line width of | (mm) | 10 | 50 | 100 | 10 | 250 | 10, 7.5 | 10, 9.5 | 10 | 500 |
| | joining layer | | | | | | | | | | |
| | Space width | (mm) | 1, 2 | 6, 5 | 11, 12 | 2, 4 | 0 | 18, 1.5 | 0.5, 0.6 | 25 | 0 |

| | | | | | |
|---|---|---|---|---|---|
| Image view of joining | Pattern 11 | Pattern 12 | Pattern 13 | Pattern 14 | Pattern 15 |
| pattern | | | | | |

TABLE 4

| | | | Example 16 | Example 17 | Example 18 | | | |
|---|---|---|---|---|---|---|---|---|
| Joining | Total contact area | (%) | 70 | | | | | |
| pattern of | percentage | | | | | | | |
| joining | Contact area | Area No. | — | — | ¼ Area(1) | ¼ Area(2) | ¼ Area(3) | ¼ Area(4) |
| layer | percentage for | (%) | — | — | 40 | 100 | 60 | 80 |
| | each area | | | | | | | |
| | Line width of | (mm) | 10 | 50 | 10 | 250 | 10 | 10 |
| | joining layer | | | | | | | |
| | Space width | (mm) | 4, 6 | 22, 20 | 15 | 0 | 6, 8 | 2, 4 |

| | | | |
|---|---|---|---|
| Image view of joining pattern | Pattern 1 | Pattern 2 | Pattern 4 |

TABLE 5

| | | | | Example 1 | Example 2 | Example 3 | Example 4 | Example 5 |
|---|---|---|---|---|---|---|---|---|
| Surface cover | Material | | | Polyester fiber | Polyester fiber | Polyester fiber | Polyester fiber | Polyester fiber |
| layer | | | | material | material | material | material | material |
| | Average fiber diameter | | (μm) | 3 | 3 | 3 | 3 | 3 |
| | Air permeation volume | | (cm³/cm² sec) | 21 | 21 | 21 | 21 | 21 |
| | Basic weight | | (g/m²) | 20 | 20 | 20 | 20 | 20 |
| | Thickness | | (mm) | 0.06 | 0.06 | 0.06 | 0.06 | 0.06 |
| | Average apparent density | | (g/cm³) | 0.33 | 0.33 | 0.33 | 0.33 | 0.33 |
| Joining layer | Material | | | Butyl rubber- | Butyl rubber- | Butyl rubber- | Butyl rubber- | Butyl rubber- |
| | | | | based double | based double | based double | based double | based double |
| | | | | sided pressure- | sided pressure- | sided pressure- | sided pressure- | sided pressure- |
| | | | | sensitive | sensitive | sensitive | sensitive | sensitive |
| | | | | adhesive tape | adhesive tape | adhesive tape | adhesive tape | adhesive tape |
| | Thickness | | (mm) | 0.5 | 0.5 | 0.5 | 0.5 | 0.5 |
| | Total joint area percentage | | (%) | 70 | 70 | 70 | 70 | 70 |
| | Storage elastic modulus | | Pa | 3.5 × 10⁵ | 3.5 × 10⁵ | 3.5 × 10⁵ | 3.5 × 10⁵ | 3.5 × 10⁵ |
| Back-surface | Material | | | Polyester fiber | Polyester fiber | Polyester fiber | Polyester fiber | Polyester fiber |
| layer | | | | felt | felt | felt | felt | felt |
| | Average fiber diameter | | (μm) | 19 | 19 | 19 | 19 | 19 |
| | Air permeation volume | | (cm³/cm² sec) | 165 | 165 | 165 | 165 | 165 |
| | Basic weight | | (g/m²) | 200 | 200 | 200 | 200 | 200 |
| | Thickness | | (mm) | 10 | 10 | 10 | 10 | 10 |
| | Average apparent density | | (g/cm³) | 0.02 | 0.02 | 0.02 | 0.02 | 0.02 |
| Soundproof | Total thickness | | (mm) | 10.6 | 10.6 | 10.6 | 10.6 | 10.6 |
| material | Reverberation | ⅓ Octave | 400 Hz | 0.16 | 0.13 | 0.16 | 0.16 | 0.17 |
| | room method | band center | 500 Hz | 0.25 | 0.23 | 0.27 | 0.28 | 0.29 |
| | sound | frequency | 630 Hz | 0.27 | 0.27 | 0.31 | 0.33 | 0.42 |
| | absorption | | 800 Hz | 0.35 | 0.36 | 0.43 | 0.44 | 0.49 |
| | coefficient | | 1000 Hz | 0.45 | 0.47 | 0.62 | 0.51 | 0.47 |
| | | | 1250 Hz | 0.54 | 0.62 | 0.84 | 0.55 | 0.43 |
| | | | 1600 Hz | 0.65 | 0.83 | 0.85 | 0.60 | 0.43 |
| | | | 2000 Hz | 0.83 | 1.02 | 0.70 | 0.67 | 0.47 |
| | | | 2500 Hz | 0.97 | 0.92 | 0.67 | 0.75 | 0.51 |
| | | | 3150 Hz | 1.02 | 0.69 | 0.59 | 0.80 | 0.55 |
| | | | 4000 Hz | 1.01 | 0.59 | 0.52 | 0.79 | 0.57 |
| | | | 5000 Hz | 0.89 | 0.54 | 0.46 | 0.72 | 0.54 |

TABLE 6

| | | | | Example 6 | Example 7 | Example 8 | Example 9 | Example 10 |
|---|---|---|---|---|---|---|---|---|
| Surface cover | Material | | | Polyester fiber | Polyester fiber | Polyester fiber | Polyester fiber | Polyester fiber |
| layer | | | | material | material | material | material | material |
| | Average fiber diameter | | (μm) | 3 | 3 | 3 | 3 | 3 |
| | Air permeation volume | | (cm³/cm² sec) | 21 | 21 | 21 | 21 | 21 |
| | Basic weight | | (g/m²) | 20 | 20 | 20 | 20 | 20 |
| | Thickness | | (mm) | 0.06 | 0.06 | 0.06 | 0.06 | 0.06 |
| | Average apparent density | | (g/cm³) | 0.33 | 0.33 | 0.33 | 0.33 | 0.33 |
| Joining layer | Material | | | Butyl rubber- | Butyl rubber- | Butyl rubber- | Butyl rubber- | Butyl rubber- |
| | | | | based double- | based double- | based double- | based double- | based double- |
| | | | | sided pressure- | sided pressure- | sided pressure- | sided pressure- | sided pressure- |
| | | | | sensitive | sensitive | sensitive | sensitive | sensitive |
| | | | | adhesive tape | adhesive tape | adhesive tape | adhesive tape | adhesive tape |
| | Thickness | | (mm) | 0.5 | 0.5 | 0.5 | 0.5 | 0.5 |
| | Total joint area percentage | | (%) | 50 | 50 | 50 | 50 | 50 |
| | Storage elastic modulus | | Pa | 3.5 × 10⁵ | 3.5 × 10⁵ | 3.5 × 10⁵ | 3.5 × 10⁵ | 3.5 × 10⁵ |
| Back-surface | Material | | | Polyester fiber | Polyester fiber | Polyester fiber | Polyester fiber | Polyester fiber |
| layer | | | | felt | felt | felt | felt | felt |
| | Average fiber diameter | | (μm) | 19 | 19 | 19 | 19 | 19 |
| | Air permeation volume | | (cm³/cm² sec) | 165 | 165 | 165 | 165 | 165 |
| | Basis weight | | (g/m²) | 200 | 200 | 200 | 200 | 200 |
| | Thickness | | (mm) | 10 | 10 | 10 | 10 | 10 |
| | Average apparent density | | (g/cm³) | 0.02 | 0.02 | 0.02 | 0.02 | 0.02 |
| Soundproof | Total thickness | | (mm) | 10.6 | 10.6 | 10.6 | 10.6 | 10.6 |
| matrial | Reverberation | ⅓ Octave | 400 Hz | 0.14 | 0.11 | 0.14 | 0.14 | 0.15 |
| | room method | band center | 500 Hz | 0.23 | 0.22 | 0.26 | 0.27 | 0.27 |
| | sound | frequency | 630 Hz | 0.25 | 0.25 | 0.29 | 0.31 | 0.40 |
| | absorption | | 800 Hz | 0.33 | 0.33 | 0.40 | 0.41 | 0.46 |
| | coefficient | | 1000 Hz | 0.41 | 0.43 | 0.59 | 0.47 | 0.43 |
| | | | 1250 Hz | 0.51 | 0.58 | 0.81 | 0.52 | 0.40 |
| | | | 1600 Hz | 0.62 | 0.79 | 0.81 | 0.56 | 0.40 |
| | | | 2000 Hz | 0.81 | 1.00 | 0.68 | 0.65 | 0.45 |
| | | | 2500 Hz | 0.96 | 0.92 | 0.67 | 0.75 | 0.51 |
| | | | 3150 Hz | 1.07 | 0.74 | 0.64 | 0.85 | 0.60 |
| | | | 4000 Hz | 1.09 | 0.67 | 0.60 | 0.87 | 0.66 |
| | | | 5000 Hz | 1.02 | 0.66 | 0.59 | 0.85 | 0.66 |

TABLE 7

| | | | | Example 11 | Example 12 | Example 13 | Example 14 | Example 15 |
|---|---|---|---|---|---|---|---|---|
| Surface cover | Material | | | Polyester fiber | Polyester fiber | Polyester fiber | Polyester fiber | Polyester fiber |
| layer | | | | material | material | material | material | material |
| | Average fiber diameter | | (μm) | 3 | 3 | 3 | 3 | 3 |
| | Air permeation volume | | (cm³/cm² sec) | 21 | 21 | 21 | 21 | 21 |
| | Basic weight | | (g/m²) | 20 | 20 | 20 | 20 | 20 |
| | Thickness | | (mm) | 0.06 | 0.06 | 0.06 | 0.06 | 0.06 |
| | Average apparent density | | (g/cm³) | 0.33 | 0.33 | 0.33 | 0.33 | 0.33 |
| Joining layer | Material | | | Butyl rubber- | Butyl rubber- | Butyl rubber- | Butyl rubber- | Butyl rubber- |
| | | | | based double- | based double- | based double- | based double- | based double- |
| | | | | sided pressure- | sided pressure- | sided pressure- | sided pressure- | sided pressure- |
| | | | | sensitive | sensitive | sensitive | sensitive | sensitive |
| | | | | adhesive tape | adhesive tape | adhesive tape | adhesive tape | adhesive tape |
| | Thickness | | (mm) | 0.5 | 0.5 | 0.5 | 0.5 | 0.5 |
| | Total joint area percentage | | (%) | 90 | 90 | 90 | 90 | 90 |
| | Storage elastic modulus | | Pa | 3.5 × 10⁵ | 3.5 × 10⁵ | 3.5 × 10⁵ | 3.5 × 10⁵ | 3.5 × 10⁵ |
| Back-surface | Material | | | Polyester fiber | Polyester fiber | Polyester fiber | Polyester fiber | Polyester fiber |
| layer | | | | felt | felt | felt | felt | felt |
| | Average fiber diameter | | (μm) | 19 | 19 | 19 | 19 | 19 |
| | Air permeation volume | | (cm³/cm² sec) | 165 | 165 | 165 | 165 | 165 |
| | Basis weight | | (g/m²) | 200 | 200 | 200 | 200 | 200 |
| | Thickness | | (mm) | 10 | 10 | 10 | 10 | 10 |
| | Average apparent density | | (g/cm³) | 0.02 | 0.02 | 0.02 | 0.02 | 0.02 |
| Soundproof | Total thickness | | (mm) | 10.6 | 10.6 | 10.6 | 10.6 | 10.6 |
| material | Reverberation | ⅓ Octave | 400 Hz | 0.19 | 0.17 | 0.19 | 0.19 | 0.20 |
| | room method | band center | 500 Hz | 0.25 | 0.30 | 0.33 | 0.28 | 0.32 |
| | sound | frequency | 630 Hz | 0.38 | 0.41 | 0.46 | 0.40 | 0.45 |
| | absorption | | 800 Hz | 0.50 | 0.53 | 0.58 | 0.52 | 0.58 |
| | coefficient | | 1000 Hz | 0.60 | 0.62 | 0.71 | 0.60 | 0.48 |
| | | | 1250 Hz | 0.68 | 0.75 | 0.61 | 0.62 | 0.42 |
| | | | 1600 Hz | 0.75 | 0.65 | 0.45 | 0.55 | 0.36 |
| | | | 2000 Hz | 0.78 | 0.51 | 0.35 | 0.49 | 0.32 |
| | | | 2500 Hz | 0.78 | 0.40 | 0.25 | 0.50 | 0.33 |
| | | | 3150 Hz | 0.75 | 0.32 | 0.18 | 0.53 | 0.38 |
| | | | 4000 Hz | 0.65 | 0.25 | 0.15 | 0.46 | 0.31 |
| | | | 5000 Hz | 0.55 | 0.20 | 0.12 | 0.42 | 0.28 |

TABLE 8

| | | | | Example 16 | Example 17 | Example 18 |
|---|---|---|---|---|---|---|
| Surface cover | Material | | | Polyester fiber | Polyester fiber | Polyester fiber |
| layer | | | | material | material | material |
| | Average fiber diameter | | (μm) | 17 | 17 | 17 |
| | Air permeation volume | | (cm³/cm² sec) | 197 | 197 | 197 |
| | Basic weight | | (g/m²) | 85 | 85 | 85 |
| | Thickness | | (mm) | 0.6 | 0.6 | 0.6 |
| | Average apparent density | | (g/cm³) | 0.14 | 0.14 | 0.14 |
| Joining layer | Material | | | Butyl rubber- | Butyl rubber- | Butyl rubber- |
| | | | | based double- | based double- | based double- |
| | | | | sided pressure- | sided pressure- | sided pressure- |
| | | | | sensitive | sensitive | sensitive |
| | | | | adhesive tape | adhesive tape | adhesive tape |
| | Thickness | | (mm) | 0.5 | 0.5 | 0.5 |
| | Total joint area percentage | | (%) | 70 | 70 | 70 |
| | Storage elastic modulus | | Pa | 3.5 × 10⁵ | 3.5 × 10⁵ | 3.5 × 10⁵ |
| Back-suface | Material | | | Polyester fiber | Polyester fiber | Polyester fiber |
| layer | | | | felt | felt | felt |
| | Average fiber diameter | | (μm) | 19 | 19 | 19 |
| | Air permeation volume | | (cm³/cm² sec) | 165 | 165 | 165 |
| | Basis weight | | (g/m²) | 200 | 200 | 200 |
| | Thickness | | (mm) | 10 | 10 | 10 |
| | Average apparent density | | (g/cm³) | 0.02 | 0.02 | 0.02 |
| Soundproof | Total thickness | | (mm) | 11.1 | 11.1 | 11.1 |
| material | Reverberation | ⅓ Octave | 400 Hz | 0.15 | 0.12 | 0.15 |
| | room method | band center | 500 Hz | 0.24 | 0.22 | 0.27 |
| | sound | frequency | 630 Hz | 0.25 | 0.25 | 0.32 |
| | absorption | | 800 Hz | 0.32 | 0.32 | 0.38 |
| | coefficient | | 1000 Hz | 0.40 | 0.42 | 0.43 |
| | | | 1250 Hz | 0.44 | 0.52 | 0.45 |
| | | | 1600 Hz | 0.54 | 0.71 | 0.42 |
| | | | 2000 Hz | 0.60 | 0.79 | 0.44 |
| | | | 2500 Hz | 0.63 | 0.58 | 0.42 |
| | | | 3150 Hz | 0.66 | 0.33 | 0.44 |
| | | | 4000 Hz | 0.69 | 0.28 | 0.48 |
| | | | 5000 Hz | 0.74 | 0.27 | 0.51 |

FIG. 17 is a graph obtained by plotting the sound absorption coefficients of the soundproof materials obtained in Examples 1-3 for each ⅓ octave band center frequency. As is clear from FIG. 17, it can be seen that as the line width of the joining layer increases from 10 mm→50 mm→100 mm, in other words, as the area of the joining layer increases from 100 cm²→500 cm²→1000 cm², the sound absorption peak frequency of the soundproof material is shifted to the lower frequency side. Also, in this case, it can be seen that as the line width of the joining layer increases similarly, the sound absorption coefficient decreases on the higher frequency range side of the sound absorption peak frequency, and the sound absorption coefficient increases on the lower frequency range side of the sound absorption peak frequency. In addition, it was observed that as the line width of the joining layer increased, the average sound absorption coefficient at ⅓ octave band center frequencies of 400 to 5000 Hz tended to decrease.

FIG. 18 is a graph obtained by plotting the sound absorption coefficients of the soundproof materials obtained in Examples 1, 4, and 5 for each ⅓ octave band center frequency. The arrangement style of the joining layers of the soundproof material of Example 4 is that, of the four equally divided areas (regional areas), three areas are each composed of a plurality of joining layers, and one area is composed of one joining layer. The arrangement style of the joining layers of the soundproof material of Example 5 is that, of the two equally divided areas (regional areas), one area is composed of a plurality of joining layers, and one area is composed of one joining layer. When the arrangement styles of the joining layers of Example 4 and Example 5 are compared, it is Example 5 that the area of the joining layer is larger and the arrangement of openings is more unbalanced. In the arrangement style of the joining layers of the soundproof material, it can be seen that, in Example 4, the sound absorption coefficient decreases in the frequency range of 1250 Hz or more, and the sound absorption coefficient increases in the frequency range of less than 1250 Hz compared to Example 1 in which the individual areas of the joining layers are small, and the openings are relatively uniformly formed and arranged over the soundproof material. Further, in Example 5, it can be seen that the sound absorption coefficient decreases in the frequency range of 1000 Hz or more, and the sound absorption coefficient increases in the frequency range of less than 1000 Hz. As a result, in Example 5 and Example 4, the sound absorption coefficients of the soundproof materials in the low to high frequency ranges were more leveled compared to Example 1.

FIG. 19 is a graph obtained by plotting the sound absorption coefficients of the soundproof materials obtained in Examples 6-8 for each ⅓ octave band center frequency. As is clear from FIG. 19, it can be seen that as the line width of the joining layer increases from 10 mm→50 mm→100 mm, in other words, as the area of the joining layer increases from 100 cm²→500 cm²→1000 cm², the sound absorption peak frequency of the soundproof material is shifted to the lower frequency side. Also, in this case, it can be seen that as the line width of the joining layer increases similarly, the sound absorption coefficient decreases on the higher frequency range side of the sound absorption peak frequency, and the sound absorption coefficient increases on the lower frequency range side of the sound absorption peak frequency. In addition, it was observed that as the line width of the joining layer increased, the average sound absorption coefficient at ⅓ octave band center frequencies of 400 to 5000 Hz tended to decrease.

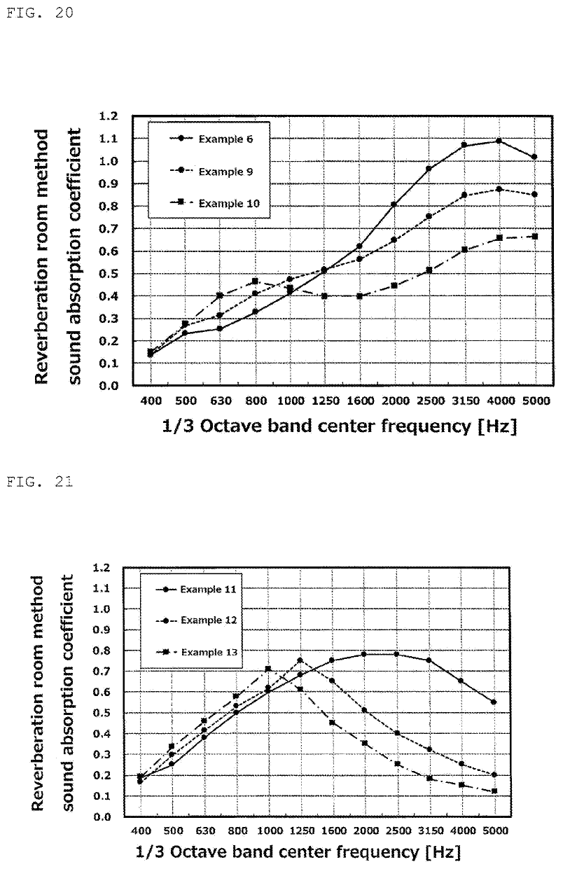

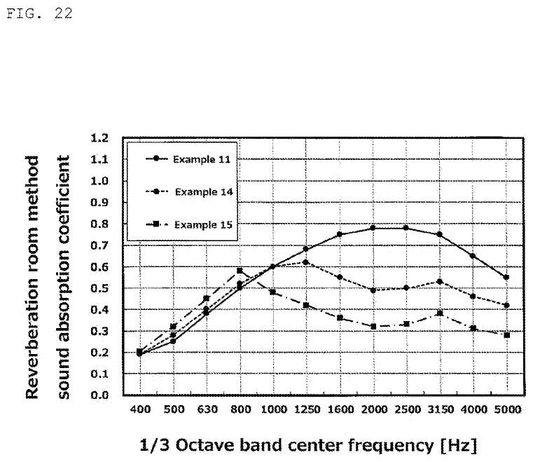

FIG. 20 is a graph obtained by plotting the sound absorption coefficients of the soundproof materials obtained in Examples 6, 9, and 10 for each ⅓ octave band center frequency. The arrangement style of the joining layers of the soundproof material of Example 9 is that, of the four equally divided areas (regional areas), two areas are each composed of a plurality of joining layers, one area is composed of one joining layer, and there is no joining layer in one area. The arrangement style of the joining layers of the soundproof material of Example 10 is that, of the two equally divided areas (regional areas), one area is composed of one joining layer, and there is no joining layer in one area. When the arrangement styles of the joining layers of Example 9 and Example 10 are compared, it is Example 10 that the area of the joining layers is larger and the arrangement of openings is more unbalanced. In the arrangement style of the joining layers of the soundproof material, it can be seen that in Example 9, the sound absorption coefficient decreases in the frequency range of 1600 Hz or more, and the sound absorption coefficient increases in the frequency range of 1250 Hz or less compared to Example 6 in which the individual areas of the joining layers are small, and the openings are relatively uniformly formed and arranged over the soundproof material. Further, in Example 10, it can be seen that the sound absorption coefficient decreases in the frequency range of 1250 Hz or more, and the sound absorption coefficient increases in the frequency range of 1000 Hz or less. As a result, in Example 9 and Example 10, the sound absorption coefficients of the soundproof materials in the low to high frequency ranges were more leveled compared to Example 6.

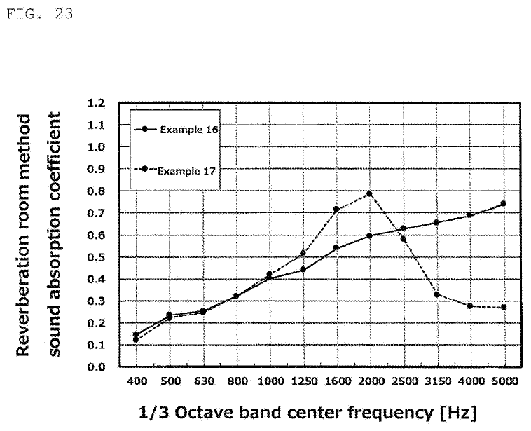

FIG. 21 is a graph obtained by plotting the sound absorption coefficients of the soundproof materials obtained in Examples 11-13 for each ⅓ octave band center frequency. As is clear from FIG. 21, it can be seen that as the line width of the joining layer increases from 10 mm→50 mm→100 mm, in other words, as the area of the joining layer increases from 100 cm²→500 cm²→1000 cm², the sound absorption peak frequency of the soundproof material is shifted to the lower frequency side. Also, in this case, it can be seen that as the line width of the joining layer increases similarly, the sound absorption coefficient decreases on the higher frequency range side of the sound absorption peak frequency, and the sound absorption coefficient increases on the lower frequency range side of the sound absorption peak frequency. In addition, it was observed that as the line width of the joining layer increased, the average sound absorption coefficient at ⅓ octave band center frequencies of 400 to 5000 Hz tended to decrease.

FIG. 22 is a graph obtained by plotting the sound absorption coefficients of the soundproof materials obtained in Examples 11, 14, and 15 for each ⅓ octave band center frequency. The arrangement style of the joining layers of the soundproof material of Example 14 is that, of the four equally divided areas (regional areas), three areas are each composed of a plurality of joining layers, and one area is composed of one joining layer. The arrangement style of the joining layers of the soundproof material of Example 15 is that, of the two equally divided areas (regional areas), one area is composed of a plurality of joining layers, and one area is composed of one joining layer. When the arrangement styles of the joining layers of Example 14 and Example 15 are compared, it is Example 15 that the area of the joining layer is larger and the arrangement of openings is more unbalanced. In the arrangement style of the joining layers of the soundproof material, it can be seen that in Example 14, the sound absorption coefficient decreases in the frequency range of 1000 Hz or more, and the sound absorption coefficient increases in the frequency range of less than 1000 Hz compared to Example 11 in which the individual areas of the joining layers are small, and the openings are relatively uniformly formed and arranged over the soundproof material. Further, in Example 15, it can be seen that the sound absorption coefficient decreases in the frequency range of 1000 Hz or more, and the sound absorption coefficient increases in the frequency range of 800 Hz or less. As a result, in Example 14 and Example 15, the sound absorption coefficients of the soundproof materials in the low to high frequency ranges were more leveled compared to Example 11.

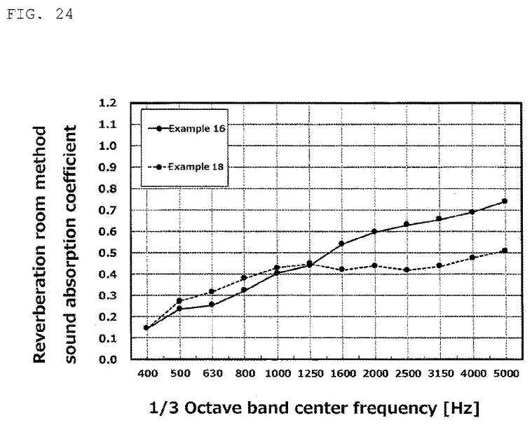

FIG. 23 is a graph obtained by plotting the sound absorption coefficients of the soundproof materials obtained in Examples 16, and 17 for each ⅓ octave band center frequency. In the soundproof material of Example 17, the line width of the joining layer is 50 mm (the area of the joining layer: 500 cm²), which has been increased compared to 10 mm (the area of the joining layer: 100 cm²) in Example 16. As a result, the sound absorption coefficient shifted to the lower frequency side of Example 16. Further, in this case, it can be seen that as the line width of the joining layer increases similarly, the sound absorption coefficient decreases on the higher frequency range side of the sound absorption peak frequency, and the sound absorption coefficient increases on the lower frequency range side of the sound absorption peak frequency. In addition, it was observed that as the line width of the joining layer increased, the average sound absorption coefficient at ⅓ octave band center frequencies of 400 to 5000 Hz tended to decrease. It can be seen that Examples 16, 17, in which the average fiber diameter of the surface cover material is 17 μm, have low sound absorption coefficients overall compared to Examples 1 and 2 in which the average fiber diameter of the surface cover material is 3 μm, though they have the same arrangement style of the joining layers.

FIG. 24 is a graph obtained by plotting the sound absorption coefficients of the soundproof materials obtained in Examples 16, and 18 for each ⅓ octave band center frequency. The arrangement style of the joining layers of the soundproof material of Example 18 is that, of the four equally divided areas (regional areas), three areas are each composed of a plurality of joining layers, and one area is composed of one joining layer. When the arrangement styles of the joining layers of Example 16 and Example 18 are compared, it is Example 18 that the area of the joining layers is larger and the arrangement of openings is more unbalanced. In the arrangement style of the joining layers of the soundproof material, it can be seen that, in Example 18, the sound absorption coefficient decreases in the frequency range of 1600 Hz or more, and the sound absorption coefficient increases in the frequency range of less than 1250 Hz or less compared to Example 16 in which the individual areas of the joining layers are small, and the openings are relatively uniformly formed and arranged over the soundproof material. As a result, in Example 18, the sound absorption coefficient of the soundproof material in the low to high frequency ranges was more leveled compared to Example 16. It can be seen that Examples 16, 18, in which the average fiber diameter of the surface cover material is 17 μm, have low sound absorption coefficients overall compared to Examples 1 and 4 in which the average fiber diameter of the surface cover material is 3 μm, though they have the same arrangement style of the joining layers.

### DESCRIPTION OF NUMERALS

10 . . . soundproof material
11 . . . surface cover layer
12 . . . joining layer
13 . . . back-surface layer
14 . . . air-permeable openings

1. A method of controlling sound absorption characteristics of a soundproof material, the soundproof material comprising:
a surface cover layer composed of a fiber material;
a back-surface layer laminated onto the surface cover layer, and composed of a porous material with voids interconnected with each other; and
one or more joining layers laminated between the surface cover layer and the back-surface layer, each joining layer being composed of a joining material, having a total joint area percentage of less than 100% with respect to the entire contact surface between the surface cover layer and the back-surface layer,
wherein the sound absorption characteristics are changed by changing individual areas of the joining layers.

2. The method of controlling sound absorption characteristics of a soundproof material according to claim 1, wherein the total joint area percentage is selected from the range of 50 to 95%.

3. The method of controlling sound absorption characteristics of a soundproof material according to claim 1, wherein the joining material is a coated pressure-sensitive adhesive or double-sided pressure-sensitive adhesive tape.

4. The method of controlling sound absorption characteristics of a soundproof material according to claim 1, wherein more than one joining layer exists on the contact surface between the surface cover layer and the back-surface layer.

5. The method of controlling sound absorption characteristics of a soundproof material according to claim 1, wherein the plurality of joining layers has a regular arrangement style.

6. The method of controlling sound absorption characteristics of a soundproof material according to claim 1, wherein the joining layer has a bar-like shape.

7. The method of controlling sound absorption characteristics of a soundproof material according to claim 1, wherein the absorption peak frequency of the soundproof material is shifted to the lower frequency side by increasing the individual areas of the joining layers, or the absorption peak frequency of the soundproof material is shifted to the higher frequency side by decreasing the individual areas of the joining layers.

8. The method of controlling sound absorption characteristics of a soundproof material according to claim 1, wherein, by increasing the individual areas of the joining layers, the sound absorption coefficient on the higher frequency range side of the sound absorption peak frequency of the soundproof material is reduced, and the sound absorption coefficient on the lower frequency range side of the sound absorption peak frequency is increased, or by reducing the individual areas of the joining layers, the sound absorption coefficient on the higher frequency range side of the sound absorption peak frequency of the soundproof material is increased, and the sound absorption coefficient on the lower frequency range side is reduced.

9. A method of controlling sound absorption characteristics of a soundproof material, the soundproof material comprising:
a surface cover layer composed of a fiber material;
a back-surface layer laminated onto the surface cover layer, and composed of a porous material with voids interconnected with each other; and
a joining layer laminated between the surface cover layer and the back-surface layer, and composed of a joining material, the joining layer having a total joint area percentage of less than 100% with respect to the entire contact surface between the surface cover layer and the back-surface layer,
wherein, on at least a part of the contact surface between the surface cover layer and the back-surface layer, one or more regional areas, each being composed of a plurality of joining layers having a predetermined arrangement style, are arranged, thereby changing the sound absorption characteristics of the soundproof material.

10. The method of controlling sound absorption characteristics of a soundproof material according to claim 9, wherein, if there is a regional area where, a regional area composed of a plurality of joining layers, is not arranged on the contact surface between the surface cover layer and the back-surface layer, a regional area composed of one joining layer, which has a larger area than the each joining layer, is arranged on at least part of the regional area.

11. The method of controlling sound absorption characteristics of a soundproof material according to claim 9, wherein the sound absorption coefficient of the soundproof material in the low to high frequency ranges is leveled.

12. The method of controlling sound absorption characteristics of a soundproof material according to claim 1, wherein the fiber material of the surface cover layer has a basis weight of 5 to 300 g/m², an average fiber diameter of 1 to 17 μm, and an air-permeation volume of 5 to 200 cm³/cm²·sec.

13. The method of controlling sound absorption characteristics of a soundproof material according to claim 9, wherein the back-surface layer has a unit-area flow resistance of 0.5×10⁴ to 3.5×10⁴ N·sec/m⁴.

14. The method of controlling sound absorption characteristics of a soundproof material according to claim 1, wherein the back-surface layer is composed of a fiber material which has a basis weight of 100 to 300 g/m².

15. The method of controlling sound absorption characteristics of a soundproof material according to claim 9, wherein the coated pressure-sensitive adhesive or double-sided pressure-sensitive adhesive tape has a shear storage elastic modulus of 1.0×10⁴ to 1.0×10⁶ Pa at 25° C.

16. The method of controlling sound absorption characteristics of a soundproof material according claim 1, wherein the back-surface layer is composed of a fiber material which has a basis weight of 100 to 300 g/m².

17. The method of controlling sound absorption characteristics of a soundproof material according claim 9, wherein the back-surface layer is composed of a fiber material which has a basis weight of 100 to 300 g/m².

18. The method of controlling sound absorption characteristics of a soundproof material according to claim 3, wherein the coated pressure-sensitive adhesive or double-sided pressure-sensitive adhesive tape has a shear storage elastic modulus of 1.0×10⁴ to 1.0×10⁶ Pa at 25° C.

19. The method of controlling sound absorption characteristics of a soundproof material according to claim 9, wherein the joining material is a coated pressure-sensitive adhesive or double-sided pressure-sensitive adhesive tape.

20. The method of controlling sound absorption characteristics of a soundproof material according to claim 19, wherein the coated pressure-sensitive adhesive or double-sided pressure-sensitive adhesive tape has a shear storage elastic modulus of 1.0×10⁴ to 1.0×10⁶ Pa at 25° C.
